(19) United States
(12) Patent Application Publication
(10) Pub. No.: US 2024/0152572 A1
(43) Pub. Date: May 9, 2024

(54) QUANTUM CONTROL

(71) Applicants: IDEADED, S.L, VILADECANS (ES); UNIVERSITAT DE BARCELONA, Barcelona (ES)

(72) Inventors: Lluc GARCIA I GONZALO, Barcelona (ES); Josep Maria BOFILL VILLÀ, Barcelona (ES); Ibério de Pinho RIBEIRO MOREIRA, Barcelona (ES); Guillermo ALBAREDA PIQUER, Barcelona (ES)

(21) Appl. No.: 18/400,709

(22) Filed: Dec. 29, 2023

(30) Foreign Application Priority Data
Dec. 30, 2022 (WO) PCT/EP2022/088078

(51) Int. Cl. G06F 17/11; G06N 10/60

(52) U.S. Cl. CPC G06F 17/11; G06N 10/60

(57) ABSTRACT

A computer implemented method and a computer to determine a control protocol Hamiltonian for a quantum process is provided. Quantum systems driven according to the control protocol Hamiltonian are provided.

### CROSS-REFERENCE TO RELATED APPLICATIONS

This U.S. non-provisional application claims priority to International Application No. PCT/EP2022/088078, entitled “QUANTUM CONTROL,” and filed Dec. 30, 2022, the entirety of which is incorporated herein by reference.

### BACKGROUND

### Technical Field

The present disclosure relates to methods and systems used for quantum control.

### Background Art

This disclosure relates to evaluating and improving performance of the control of a quantum process.

Quantum information deteriorates quickly, and complex algorithms are required to create control protocols that can stabilize the quantum information processing.

Engineering a suitable control protocol or Hamiltonian that evolves a given initial quantum state into a selected target state is essential in technologies such as quantum information processing, quantum simulation, and quantum sensing. Inspired by Pontryagin's maximum principle, this problem has traditionally been addressed using optimal quantum control theory, where state transformations are implemented using, for example, open loop or measurement-based protocols. Some approaches to find a quantum control consist of parametrically optimizing a fixed form of the control Hamiltonian to reach maximum fidelity and/or pre-setting an elapsed time over which the evolution is performed.

In a time-optimal version of quantum control theory, some maximum fidelity transformations are sought in the least possible time to reduce the impact of decoherence, which rapidly degrades the quality of quantum states in quantum information processing. A formal time-optimal version of quantum control theory was formulated by Carlini and coworkers in analogy to Bernoulli's classical brachistochrone problem and has since then been referred to as the quantum brachistochrone problem. A solution to the quantum brachistochrone problem may be finding a time-independent Hamiltonian that generates maximum speed of evolution along a geodesic, if the time evolution has no constraints. There may be limitations prohibiting the implementation of such solution, especially for open quantum systems. In closed systems, restrictions may come from the available forms of the control Hamiltonian, which may yield a difficult-to-solve boundary-value problem. In cases where the form of the control Hamiltonian can be relaxed, limitations may arise in situations where the system is immersed in an external field that cannot be altered by the controller. In analogy with the classical problem posed by Zermelo, this last situation has been often called the quantum Zermelo navigation problem. The quantum Zermelo problem has been recently addressed for systems in a time-independent driving force and for initial and target states with at most a real overlap.

### SUMMARY

The present disclosure provides a general solution for transforming between arbitrary quantum states in the presence of a time-dependent drift Hamiltonian.

In an aspect of the disclosure, there is presented a computer implemented method to determine a control protocol Hamiltonian for a quantum process, the method comprising: providing a time dependent Hermitian drift Hamiltonian H₀(t), an initial state |ψᵢ [symbol] , a final state, |ψ_{f} [symbol] , and either a finite energy resource of the control protocol v_{z}(t), or a protocol time τ and a functional form of v_{z}(t) with respect to time t; iteratively equating an equation expressed as ∫₀^{τ}v_{z}(t)dt=arc cos| [symbol] ψᵢ|ψ′_{f} [symbol] |, wherein, in each iteration, values of either a protocol time τ or values of a finite energy resource of the control protocol v_{z}(t), are modified until both sides of the equation are at least substantially equal; obtaining thereby either a protocol time τ or a finite energy resource of the control protocol v_{z}(t); constructing a control protocol Hamiltonian in an interaction picture with respect to H₀(t), H′_{c}(t) according to

$${H}_{c}^{′} ( t ) = \frac{i {v}_{z} ( t )}{\sqrt{I - {s}^{2}}} ( {e}^{- i β} \vert {ψ}_{f}^{′} 〉 〈 {ψ}_{i} \vert - {e}^{i β} \vert {ψ}_{i} 〉 〈 {ψ}_{f}^{′} \vert )$$

where s and β are defined through [symbol] ψᵢ|ψ′_{f}(τ) [symbol] = [symbol] ψᵢ| [symbol] ₀^{†}(τ)|ψ_{f} [symbol] =se^{iβ}, and parameters in the interaction picture represent, each: s modulus; β phase; |ψ′_{f} [symbol] the final state |ψ_{f} [symbol] , in the interaction picture, with |ψ′_{f} [symbol] = [symbol] ₀^{†}(τ)|ψ_{f} [symbol] , where [symbol] ₀(τ)= [symbol] exp(−i∫₀^{τ}H₀(t₁)dt₁) and [symbol] defines a time ordering operator; and † means conjugate transpose; and determining the control protocol Hamiltonian in the Schrödinger picture as H_{c}(t)= [symbol] ₀(t)H′_{c}(t) [symbol] ₀^{†}(t).

The computer implemented method may be implemented in a computer. In the present disclosure, quantum process may comprise any one or more of quantum technologies, such as sensing, or metrology, or communication, or quantum simulation, or quantum operations, or quantum computing. The computer implemented method may be provided with either a finite energy resource of the control protocol v_{z}(t) or a protocol time τ; v_{z}(t) and τ are related through ∫₀^{τ}v_{z}(t)dt=arc cos|ψᵢ|ψ′_{f} [symbol] |. In some examples the finite energy resource of the control protocol v_{z}(t) is provided and a protocol time τ is computed or determined. In other examples a protocol time τ is provided and the finite energy resource of the control protocol v_{z}(t) is computed or determined provided a functional form of v_{z}(t) with respect to time t.

The resolution of either τ or v_{z}(t) is performed iteratively until a condition is reached, for example, given a provided v_{z}(t), values for τ may be modified by predefined steps or by random modifications for each iteration until both sides of the equation are equal within a certain tolerance, for example, both sides of the equation may differ by a tolerance or by a difference which is smaller than a tolerance. Any iterative method may solve the equation to determine either τ or v_{z}(t). Any modification, for example, increasing values of τ or v_{z}(t) or random values of τ or v_{z}(t) may solve the equation. The control protocol Hamiltonian is constructed in an interaction picture with respect to H₀(t).

A consequence of applying a control protocol Hamiltonian according to the present disclosure provides the energy resource of the control and the control Hamiltonian being related through the following equation v_{z}(t)=ΔH′_{c}(t), where ΔH′_{c}(t) is the variance of the control Hamiltonian in the interaction picture.

Given an initial state |ψᵢ [symbol] and a time-dependent drift Hamiltonian H₀(t), a time optimal control Hamiltonian H_{c}(t) is sought, such that the total Hamiltonian H(t)=H₀(t)+H_{c}(t) drives |ψᵢ [symbol] to the desired final state |ψ_{f} [symbol] in the least possible time τ according to the time-dependent Schrödinger equation, i(d/dt)|ψ(t) [symbol] =H(t)|ψ(t) [symbol] (atomic units are used throughout). The form of the drift Hamiltonian is not manipulable, while the control Hamiltonian is only constrained to fulfill two conditions: (i) it has a finite energy bandwidth, and (ii) it is restricted to a subspace of Hermitian operators. The control provided in the present disclosure allows evolving the initial state to the final state with unit fidelity=1 and in the minimum possible time, which advantageously minimizes the impact of decoherence on the quantum process. In other words, for a given coherence time Tc, reducing the time τ for realizing a quantum process (i.e., τ<<Tc) has the clear advantage of minimizing the effect of decoherence.

In order to provide the control protocol Hamiltonian, the methods of the present disclosure are provided with a time dependent Hermitian drift Hamiltonian H₀(t), an initial state |ψᵢ [symbol] , a final state, |ψ_{f} [symbol] , and: either a) with a finite energy resource of the control protocol v_{z}(t), or b) with a protocol time τ and a functional form of v_{z}(t) with respect to time t. If a finite energy resource of the control protocol v_{z}(t) is provided, then such energy may be constant in time or depend on time. If a protocol time τ is given, and the finite energy resource of the control protocol is searched and dependent on time, then a functional form of v_{z}(t) with respect to time is necessary for solving the equation to obtain v_{z}(t). For example, v_{z}(t)=cos(a·t), where a is to be found by solving the equation. In the case where a protocol time τ is given, and the finite energy resource of the control protocol is searched and constant in time, then no functional form depending on time is necessary for solving the equation to obtain v_{z}(t).

In examples, the computer implemented methods of the present disclosure further comprise time-evolving the initial state |ψᵢ [symbol] , during the protocol time τ, according to the following time-dependent Schrödinger equation:

$$i \frac{d}{dt} \vert ψ ( t ) 〉 = H ( t ) \vert ψ ( t ) 〉 ,$$

where H(t)=H₀(t)+H_{c}(t).

Time-evolving the initial state |ψᵢ [symbol] , during the protocol time τ, allows arriving to a final quantum state. The time-evolution allows evaluating an expectation value of an observable or quantity of interest for example, cost and/or adiabaticity, as detailed further below.

In examples, the energy resource of the control protocol v_{z}(t) is provided and assumed independent from time and equal to v_{z}, and wherein computing the protocol time τ is performed by iteratively computing an equation expressed as

$$τ = \frac{1}{{v}_{z}} arccos \vert 〈 {ψ}_{i} \vert {ψ}_{f}^{l} 〉 \vert ,$$

where, in each iteration, values of protocol time τ are modified until both sides of the equation are at least substantially equal.

In examples, the computer implemented methods of the present disclosure may comprise providing or receiving or establishing the energy resource of the control protocol independent from time and equal to v_{z}, and where computing the protocol time τ is performed by iteratively computing an equation expressed as

$$τ = \frac{1}{{v}_{z}} arccos \sqrt{{ℱ}_{0}} ,$$

where [symbol] ₀≡| [symbol] ψᵢ|ψ′_{f} [symbol] |² is the fidelity of the process dictated by the drift Hamiltonian, and
|ψ′_{f} [symbol] = [symbol] ₀^{†}(τ)|ψ_{f} [symbol] , where [symbol] ₀(τ)= [symbol] exp(−i∫₀^{τ}H₀(t₁)dt₁) and [symbol] is the time ordering operator,
where, in each iteration, values of protocol time τ are modified until both sides of the equation are at least substantially equal.

In these examples where v_{z} is constant, the expression

$${\int }_{0}^{τ} {v}_{z} ( t ) dt = arccos \vert 〈 {ψ}_{i} \vert {ψ}_{f}^{′} 〉 \vert$$

$$becomes$$

$$τ = \frac{1}{{v}_{z}} arccos \sqrt{{ℱ}_{0}} .$$

The constant energy resource of the control protocol v_{z} may be set to a maximum available value.

In examples, the computer implemented methods of the present disclosure may comprise computing a protocol time τ or the energy resource of the control protocol v_{z}(t) by performing a bisection method with a predefined step dt obtaining a value of τ for each iteration until ∫₀^{τ}v_{z}(t)dt and arc cos| [symbol] ψᵢ|ψ′_{f} [symbol] | are at least substantially equal, wherein substantially equal comprises that ∫₀^{τ}v_{z}(t)dt approximates to arc cos| [symbol] ψᵢ|ψ′_{f} [symbol] | within a tolerance.

In examples, the computer implemented methods of the present disclosure may comprise computing a protocol time τ or the energy resource of the control protocol v_{z}(t):
by computing | [symbol] ψᵢ|ψ′_{f} [symbol] |, solving the Schrodinger equation |ψ′_{f}= [symbol] ₀^{†}(τ)|ψ′_{f} [symbol] ; in some examples a Runge-Kutta method of 4th order may be used for solving the Schrödinger equation;
and by performing a bisection method with a predefined step dt, which in examples may be 5×10⁻⁶ atomic units, obtaining a value of τ for each iteration until ∫₀^{τ}v_{z}(t)dt and arc cos| [symbol] ψᵢ|ψ′_{f} [symbol] | are at least substantially equal, wherein substantially equal comprises that ∫₀^{τ}v_{z}(t)dt approximates to arc cos| [symbol] ψᵢ|ψ′_{f} [symbol] | with a tolerance, for example a tolerance of 10⁻⁵.

As said, the methods of the present disclosure are provided either a) with a finite energy resource of the control protocol v_{z}(t), or b) with a protocol time τ and a functional form of v_{z}(t) with respect to time t. If a protocol time τ is given, and the finite energy resource of the control protocol is searched and dependent on time, then a functional form of v_{z}(t) with respect to time is necessary for solving the equation to obtain v_{z}(t).

In some examples, the computer implemented methods of the present disclosure may comprise time-evolving the initial state |ψᵢ [symbol] , during the protocol time τ, according to the time-dependent Schrödinger equation

$$i \frac{d}{dt} \vert ψ ( t ) 〉 = H ( t ) \vert ψ ( t ) 〉 ,$$

where H(t)=H₀(t)+H_{c}(t). When v_{z}(t)=v_{z}, then H_{c}(t) is computed according to dH_{c}/dt=−i[H₀,H_{c}]. In particular, time-evolving the initial state |ψᵢ [symbol] as well as the control Hamiltonian H_{c}(t) at time t=0 (i.e., H_{c}(0)) may be performed by using a Runge-Kutta method of 4th order.

In some examples, the methods of the present disclosure may comprise computing any of the following quantities:
a. a unit fidelity of the control process as:

[symbol]

=| [symbol] ψ_{f}| [symbol] (τ)|ψᵢ [symbol] |²,
where [symbol] (τ)= [symbol] exp(−i∫₀^{τ}H(t′)dt′), and where [symbol] defines the usual time ordering operator, and H(t)=H₀(t)+H_{c}(t); and/or
b. a cost as:

$${𝒞}_{T} = \frac{1}{τ} {\int }_{0}^{τ} ‖ H ( t ) ‖ dt , where ‖ H ( t ) ‖ = \sqrt{tr [ {H}^{2} ( t ) ] / 2}$$

and H(t) is the total Hamiltonian including the drift and control Hamiltonians; and/or
c. an adiabaticity as:

$$\overline{𝒜} = \frac{1}{τ} {\int }_{0}^{τ} 𝒜 ( t ) dt ,$$

where [symbol] (t)=| [symbol] g(t)|ψ(t) [symbol] |² quantifies how close the evolved state of the system is to the instantaneous ground state of H₀(t); where g(t) is the instantaneous ground (eigen) state of H₀(t).

Computing the fidelity may prove that the fidelity is maximum and equal to 1 when implementing the computer implemented methods according to the present disclosure.

In some examples, the methods of the present disclosure comprise establishing a one-to-one correspondence between the interaction of one or more fields \vec{F}_{ι} with an N level system and the control protocol Hamiltonian of the present disclosure. These examples allow obtaining control fields \vec{F} to control the interaction of the fields \vec{F}_{ι} with the N level system, as exemplified below.

In some examples, the system is a 2-level system, i.e., N is 2, and the one-to-one correspondence between the interaction of one or more fields \vec{F}_{ι} with the 2-level system and the control protocol Hamiltonian comprises the interaction of at least one field with a 2-level system and the control protocol Hamiltonian, and the one-to-one correspondence is established as

$${H}_{c} ( t ) = {\sum }_{i} ( \vec{{F}_{ι}} ( t ) \cdot \vec{σ} ) = {\sum }_{i} ( {μ}_{i} ( t ) {σ}_{x} - {γ}_{i} ( t ) {σ}_{y} + {ϵ}_{i} ( t ) {σ}_{z} ) ;$$

where Σᵢ(\vec{F}_{ι}(t)·\vec{σ})=Σᵢ(μᵢ(t)σₓ−γᵢ(t)σ_{y}+ϵᵢ(t)σ_{z}) represents the sum of the possible fields \vec{F}_{ι}, where \vec{F}=Σᵢ(\vec{F}_{ι}(t)), and \vec{σ}=(σₓ, σ_{y}, σ_{z}), is the vector of Pauli matrices corresponding to the system.

In some of these examples, establishing a one-to-one correspondence is performed by establishing a one-to-one correspondence between a magnetic field \vec{B}(t) with a particle with 2 independent quantum states characterized by g the g-factor, m the mass of the particle and q the charge of the particle, and the control protocol Hamiltonian as:

$${H}_{c} ( t ) = - ξ \vec{B} ( t ) \cdot \vec{S} = - \frac{ξ}{2} ( {B}_{x} ( t ) {σ}_{x} + - {B}_{y} ( t ) {σ}_{y} + {B}_{z} ( t ) {σ}_{z} ) ;$$

and wherein the components of \vec{B}(t) are expressed as:

$${B}_{x} ( t ) = - \frac{2 μ ( t )}{ξ} , {B}_{y} ( t ) = \frac{2 γ ( t )}{ξ} , {B}_{z} ( t ) = - \frac{2 ϵ ( t )}{ξ} ;$$

ξ=gq/2m; and where \vec{B}(t)=Σᵢ(\vec{B}_{ι}(t)).

In such examples, the computer implemented methods of the present disclosure may be implemented to control a system comprising one or more particles, immersed either in a time-varying control magnetic field or in a control optical lattice. The control magnetic field or the control optical lattice may be the sum of two or more magnetic fields or two or more optical lattices respectively.

In a further aspect, the present disclosure defines a quantum system comprising:
one or more drift fields; the fields may comprise magnetic or optical, or similar fields, which are external to the system, where external to the system comprises that the energy of the field is not within the total Hamiltonian H(t)=H₀(t)+H_{c}(t);
one or more particles immersed in the one or more drift fields;
wherein the one or more particles immersed in the one or more drift fields are in an initial quantum state |ψᵢ [symbol] , defined as the ground (eigen) state of the drift Hamiltonian H₀(t) at time t=0;
at least one control field generator configured to generate one or more time dependent control fields \vec{F};
wherein the generator is configured to drive the particle to a final quantum state |ψ_{f} [symbol] , defined as the ground (eigen) state of the drift Hamiltonian H₀(t) at time t=τ by means of the one or more time dependent control fields \vec{F}, wherein the one or more time dependent control fields \vec{F} are characterized by \vec{F}=Σᵢ(\vec{F}_{ι}(t)), with \vec{F} determined by a method according to the present disclosure.

Advantageously, a system according to the aspect of the present disclosure drives a particle from an initial state to a final state in a minimum time and with maximum fidelity. The system comprises one or more particles immersed in at least one drift field and at least one control field.

In examples of the quantum system according to the present disclosure:
the one or more drift fields comprise at least a unidirectional magnetic field B_{z0}(t);
the one or more particles comprise one particle characterized by a spin ½, a mass m, a g-factor g and a charge q; the one particle is immersed in the unidirectional magnetic field B_{z0}(t); wherein the one particle is in an initial quantum state |ψᵢ [symbol] , defined as the ground (eigen) state of the drift Hamiltonian H₀(t) at time t=0;
where the unidirectional magnetic field B_{z0}(t)and the one particle are defined by a time dependent Hermitian drift Hamiltonian

$${H}_{0} ( t ) = - \frac{ξ}{2} {B}_{z o} ( t ) {σ}_{z} ,$$

where ξ=gq/2m;
the at least one field generator comprises at least one magnetic field generator configured to generate a three-dimensional time dependent magnetic field \vec{B}(t) defined by the following components

$${B}_{x} ( t ) = - \frac{2 μ ( t )}{ξ} , {B}_{y} ( t ) = \frac{2 γ ( t )}{ξ} , {B}_{z} ( t ) = - \frac{2 ϵ ( t )}{ξ}$$

wherein the at least one magnetic field generator is configured to drive the particle to a final quantum state |ψ_{f} [symbol] , defined as the ground (eigen) state of the drift Hamiltonian H₀(t) at time t=τ; by means of the one or more time dependent control fields \vec{F}, wherein the one or more time dependent control fields \vec{F} comprises a time dependent magnetic field \vec{B}(t), wherein the time dependent magnetic field \vec{B}(t) is characterized in that

$$H ( t ) = {H}_{0} ( t ) + {H}_{c} ( t ) = - \frac{ξ}{2} {B}_{z o} ( t ) {σ}_{z} - ξ \vec{B} ( t ) \cdot \vec{S} = - \frac{ξ}{2} {B}_{z o} ( t ) {σ}_{z} - \frac{ξ}{2} ( {B}_{x} ( t ) {σ}_{x} + {B}_{y} ( t ) {σ}_{y} + {B}_{z} ( t ) {σ}_{z} ) ,$$

with a control protocol Hamiltonian

$${H}_{c} ( t ) = {𝒰}_{0} ( t ) {H}_{c}^{′} ( t ) {𝒰}_{0}^{†} ( t ) = - \frac{ξ}{2} ( {B}_{x} ( t ) {σ}_{x} + {B}_{y} ( t ) {σ}_{y} + {B}_{z} ( t ) {σ}_{z} )$$

determined by a method according to any one of the methods of the present disclosure.

In examples of the quantum system according to the present disclosure:
the one or more drift fields comprise at least an optical lattice, the optical lattice comprising one or more laser sources;
the one or more particles comprise one or more atoms trapped in the optical lattice and defined by a time dependent Hermitian two-level drift Hamiltonian H₀(t)=Γ_{zo}(t)σ_{z} and the one more atoms in an initial quantum state |ψᵢ [symbol] , defined as the ground (eigen) state of the drift Hamiltonian H₀(t) at time t=0;
the at least one field generator comprises at least one or more lasers sources configured to drive the one or more atoms trapped in the optical lattice to a final quantum state |ψ_{f} [symbol] defined as the ground (eigen) state of the drift Hamiltonian H₀(t) at time t=τ, wherein the at least one or more lasers sources are characterized in that

H(t)=H₀(t)+H_{c}(t)=Γ_{zo}(t)σ_{z}+(Γₓ(t)σₓ+Γ_{y}(t)σ_{y}+Γ_{z}(t)σ_{z}),
with a control protocol Hamiltonian H_{c}(t)=Γₓ(t)σₓ+Γ_{y}(t)σ_{y}+Γ_{z}(t)σ_{z}= [symbol] ₀(t)H′_{c}(t) [symbol] ₀^{†}(t), where H_{c}(t) determined by a method according to any one of the methods of the present disclosure.

In a further aspect, the present disclosure defines a computer configured to determine a control protocol Hamiltonian for a quantum process, by implementing a method to determine a control protocol Hamiltonian for a quantum process, the method comprising: providing a time dependent Hermitian drift Hamiltonian H₀(t), an initial state |ψᵢ [symbol] , a final state, |ψ_{f} [symbol] , and either a finite energy resource of the control protocol v_{z}(t), or a protocol time τ and a functional form of v_{z}(t) with respect to time t; iteratively equating an equation expressed as ∫₀^{τ}v_{z}(t)dt=arc cos| [symbol] ψᵢ|ψ′_{f} [symbol] |, wherein, in each iteration, values of either a protocol time τ or values of a finite energy resource of the control protocol v_{z}(t), are modified until both sides of the equation are at least substantially equal; obtaining thereby either a protocol time r or a finite energy resource of the control protocol v_{z}(t); constructing a control protocol Hamiltonian in an interaction picture with respect to H₀(t), H′_{c}(t) according to

$${H}_{c}^{′} ( t ) = \frac{i {v}_{z} ( t )}{\sqrt{1 - {s}^{2}}} ( {e}^{- i β} \vert {ψ}_{f}^{′} 〉 〈 {ψ}_{i} \vert - {e}^{i β} \vert {ψ}_{i} 〉 〈 {ψ}_{f}^{′} \vert )$$

where s and β are defined through [symbol] ψᵢ|ψ′_{f}(τ) [symbol] = [symbol] ψᵢ| [symbol] ₀^{†}(τ)|ψ_{f} [symbol] =se^{iβ}, and parameters in the interaction picture represent, each: s modulus; β phase; |ψ′_{f} [symbol] the final state |ψ_{f} [symbol] , in the interaction picture, with |ψ′_{f} [symbol] = [symbol] ₀^{†}(τ)|ψ_{f} [symbol] , where [symbol] ₀(τ)= [symbol] exp(−i∫₀^{τ}H₀(t₁)dt₁) and [symbol] defines a time ordering operator; and † means conjugate transpose; and determining the control protocol Hamiltonian in the Schrödinger picture as H_{c}(t)= [symbol] ₀(t)H′_{c}(t) [symbol] ₀^{†}(t).

In some examples, the computer may be further configured to time-evolve the initial state |ψᵢ [symbol] , during the protocol time τ, according to the following time-dependent Schrödinger equation:

$$i \frac{d}{dt} \vert ψ ( t ) 〉 = H ( t ) \vert ψ ( t ) 〉 ,$$

where H(t)=H₀(t)+H_{c}(t), or equivalently |ψ(t) [symbol] = [symbol] ₀(t) [symbol] _{c}(t)|ψᵢ [symbol] , where i [symbol] _{c}(t)=H′_{c}(t) [symbol] _{c}(t).

In some examples, the computer may be further configured to establish a one-to-one correspondence between the interaction of one or more fields \vec{F}_{ι} with an N level system and the control protocol Hamiltonian H_{c}(t); wherein, when N is 2, the control protocol Hamiltonian comprises the interaction of at least one field \vec{F}_{ι} with the 2-level system and the control protocol Hamiltonian, and the one-to-one correspondence is established as: H_{c}(t)=Σᵢ(\vec{F}_{ι}(t)·\vec{σ})=Σᵢ(μᵢ(t)σₓ−γᵢ(t)σ_{y}+ϵᵢ(t)σ_{z}); where Σᵢ(\vec{F}_{ι}(t)·\vec{σ})=Σᵢ(μᵢ(t)σₓ−γᵢ(t)σ_{y}+ϵᵢ(t)σ_{z}) represents the sum of the possible fields \vec{F}_{ι}, where \vec{F}=Σᵢ(\vec{F}_{ι}(t)), and \vec{σ}=(σₓ, σ_{y}, σ_{z}), is the vector of Pauli matrices corresponding to the system.

### BRIEF DESCRIPTION OF THE DRAWINGS

FIG. 1A shows the fidelity, [symbol] ₀ as a function of τ for ω=2, either for Γₗᵢₙₑₐᵣ or Γ_{poly}.

FIG. 1B represents the duration of the protocol time τ as a function of the energy resource of the control v_{z}.

FIG. 2 represents the duration of the protocol time, τ, in the presence (solid lines) and in the absence (dashed lines) of the drift Hamiltonian Ho=H_{LZ} with Γₗᵢₙₑₐᵣ.

FIG. 3 represents the evolution of the energy of the system [symbol] E [symbol] = [symbol] ψ(t)|H_{LZ}(t)|ψ(t) [symbol] for all possible values of v_{z} (solid line) and for ω=0 (left figure) and ω=1 (right figure).

FIG. 4 represents the time-averaged adiabaticity [symbol] , as a function of τ for Γₗᵢₙₑₐᵣ.

FIG. 5 represents the cost of implementing the proposed protocol of this disclosure.

FIG. 6 represents the time-dependence of the functions μ(t), γ(t) and ϵ(t) for different values of the protocol time τ for the particular case of ω=0.1 and Γₗᵢₙₑₐᵣ.

FIG. 7 represents a computer configured to determine a control protocol Hamiltonian for a quantum process of a quantum system.

FIG. 8 represents a quantum system comprising the computer of the present disclosure.

### DETAILED DESCRIPTION

The quantum Zermelo navigation problem can be recast in an interaction picture of quantum mechanics by writing initial and final states respectively as |ψ′ᵢ [symbol] =|ψ [symbol] and |ψ′_{f} [symbol] = [symbol] ₀^{†}(τ)|ψ_{f} [symbol] , where [symbol] ₀(t)= [symbol] exp(−i∫₀^{t}H₀(t₁)dt₁) and [symbol] defines a usual time ordering operator.

For a N-dimensional setting, adopting an approach in the projective Hilbert space [symbol] ( [symbol] _{N}), and using the Riemannian metric of Fubini and Study in “G. Fubini, Sulle metriche definite da una forma Hermitiana, Atti Ist. Veneto 63, 501 (1903-04)” and “E. Study, Math. Ann. 60, 321 (1905)”, which in the interaction picture reads as Eq. 1

$$d {ℒ}_{F S}^{2} = 4 ( \frac{〈 d {ψ}^{′} \vert d {ψ}^{′} 〉}{〈 {ψ}^{′} \vert {ψ}^{′} 〉} - \frac{{\vert 〈 {ψ}^{l} \vert d {ψ}^{′} 〉 \vert}^{2}}{{〈 {ψ}^{′} \vert {ψ}^{′} 〉}^{2}} ) , \qquad Eq . 1$$

with |ψ′(t) [symbol] = [symbol] ₀^{†}(t)|ψ(t) [symbol] and introducing the time dependent Schrödinger equation into d [symbol] _{FS}², allows setting the length of the path followed by a normalized quantum state, i.e., Eq. 2: [symbol] _{FS}=2∫₀^{τ}ΔH′_{c}(t)dt,
where ΔH′_{c}(t) denotes the standard deviation of the control Hamiltonian H′_{c}(t). Since the minimum distance path, or geodesic, between two states lies entirely in the subspace spanned by these two states, a state evolving along this path reads as Eq. 3: |ψ′(t) [symbol] =η(t)|ψᵢ [symbol] +ζ(t)|ψ̅′_{f} [symbol] ,
where |ψ̅′_{f} [symbol] =(1/\sqrt{1−s²})(|ψ′_{f} [symbol] −se^{iβ}|ψᵢ [symbol] ) with [symbol] ψᵢ|ψ′_{f} [symbol] =se^{iβ}) is the orthonormalized final state in the interaction picture. The Fubini-Study distance along a geodesic, [symbol] _{FS}^{min}, is obtained by inserting Eq. 3 into Eq. 1, integrating d [symbol] _{FS} to obtain [symbol] _{FS} and then minimizing the length, resulting in Eq. 4: [symbol] _{FS}^{min}(i,f′)=2 arc cos(| [symbol] ψᵢ|ψ′_{f} [symbol] |).

Now, a state having evolved along a geodesic must obey [symbol] _{FS}= [symbol] _{LS}^{min}(i,f′). Furthermore, imposing the “transversality” condition given by Eq. 5: [symbol] ψ′(t)|H′_{c}(t)|ψ′(t) [symbol] =i [symbol] ψ′(t)|ψ′(t) [symbol] =0, then the integrand of Eq. 2 takes its highest value (i.e., ΔH′_{c}=\sqrt{ [symbol]ψ′(t)|H′_{c}²(t)|ψ′(t) [symbol]}), thereby minimizing the upper limit of the integral τ. The above transversality condition allows inferring a functional form of H′_{c}(t), which is given by Eq. 6:

$${H}_{c}^{′} ( t ) = i ( \frac{d \vert {ψ}^{′} ( f ) 〉}{dt} 〈 {ψ}^{′} ( t ) \vert - \vert {ψ}^{l} ( t ) 〉 \frac{d 〈 {ψ}^{′} ( f ) \vert}{dt} ) .$$

To express the above Hamiltonian in terms of initial and final states, the specific form of the state in Eq. 3 is fixed. For that, the complex functions η(t)=cos θ(t) and ζ(t)=e^{-iβ} sin θ(t) [where θ(t)=∫₀^{t}ΔH′_{c}(t′)dt′] are defined and Eq. 3 (Eq. 3: |ψ′(t) [symbol] =η(t)|ψᵢ [symbol] +ζ(t)|ψ̅′_{f} [symbol] ), is introduced into Eq. 6

$$( {H}_{c}^{′} ( t ) = i ( \frac{d \vert {ψ}^{′} ( f ) 〉}{dt} 〈 {ψ}^{′} ( t ) \vert - \vert {ψ}^{′} ( t ) 〉 \frac{d 〈 {ψ}^{′} ( t ) \vert}{dt} ) ) , \qquad Eq . 6$$

obtaining

$${H}_{c}^{′} ( t ) = \frac{{iv}_{z} ( t )}{\sqrt{1 - {s}^{2}}} ( {e}^{- i β} \vert {ψ}_{f}^{′} 〉 〈 {ψ}_{i} \vert - {e}^{i β} \vert {ψ}_{i} 〉 〈 {ψ}_{f}^{′} \vert ) , \qquad Eq . 7$$

where v_{z}(t)=\sqrt{|ψ′(t)|²}=ΔH′_{c}(t), represents the “velocity” with the second equality coming from the transversality condition (Eq. 5).

For deriving the complex functions η(t)=cos θ(t) and ζ(t)=e^{-iβ} sin θ(t) [where θ(t)=∫₀^{t}ΔH′_{c}(t′)dt′], that define the geodesic path along which initial and final state are connected, the following may be implemented:

The geodesic path in Eq. 3 can be recast as:

$$\vert {ψ}^{′} ( t ) 〉 = ( η ( t ) - \frac{s {e}^{i β}}{\sqrt{1 - {s}^{2}}} ζ ( t ) ) \vert {ψ}_{i} 〉 + \frac{ζ ( t )}{\sqrt{1 - {s}^{2}}} \vert {ψ}_{f}^{′} 〉 ,$$

in terms of initial and final states.

From the above equation, the boundary values of the functions of interest can be defined. For t=0:

η(0)=1

ζ(0)=0

while for t=τ:

$$η ( τ ) - ζ ( τ ) \frac{s {e}^{i β}}{\sqrt{1 - {s}^{2}}} = 0 ,$$

$$ζ ( τ ) \frac{1}{\sqrt{1 - {s}^{2}}} = {e}^{i α} ,$$

where in the second equation the final state is allowed to acquire a global phase during the evolution. Inserting

$$ζ ( τ ) into η ( τ ) - ζ ( τ ) \frac{s {e}^{i β}}{\sqrt{1 - {s}^{2}}} , η ( τ ) = s {e}^{i ( α + β )} = s ,$$

where α=−β such that η(t) is a real function. Thus:

$$η ( τ ) = s ,$$

$$ζ ( τ ) = {e}^{- i β} \sqrt{1 - {s}^{2}} .$$

Given the above boundary conditions:

$$η ( 0 ) = 1$$

$$ζ ( 0 ) = 0$$

$$η ( τ ) = s ,$$

$$ζ ( τ ) = {e}^{- i β} \sqrt{1 - {s}^{2}} .$$

an ansatz that fulfils the four boundary conditions may be proposed:

η(t)=cos θ(t),

ζ(t)=e^{-iβ} sin θ(t),

where the angle θ(t) can be fixed by realizing that | [symbol] \dot{ψ}′(t)|\dot{ψ}′(t) [symbol] |=\dot{θ}²(t) and then using the form of the control Hamiltonian in Eq. 6

$$( {H}_{c}^{′} = i ( \frac{d \vert {ψ}^{′} ( t ) 〉}{dt} 〈 {ψ}^{′} ( t ) \vert - \vert {ψ}^{′} ( t ) 〉 \frac{d 〈 {ψ}^{′} ( t ) \vert}{dt} ) ) : \qquad Eq . 6$$

$$θ ( t ) = {\int }_{0}^{t} Δ {H}_{c}^{′} ( {t}^{′} ) {dt}^{′} .$$

The above ansatz confirms that (i) the initial state |ψᵢ [symbol] is monotonically brought closer to the final state |ψ′_{f} [symbol] and (ii) that this happens at maximum speed given a particular energy resource of the control v_{z}(t). The first statement (i) can be proven by noting that the amplitudes accompanying initial and final states in

$$\vert {ψ}^{′} ( t ) 〉 = ( η ( t ) - \frac{s {e}^{i β}}{\sqrt{1 - {s}^{2}}} ζ ( t ) ) \vert {ψ}_{i} 〉 + \frac{ζ ( t )}{\sqrt{1 - {s}^{2}}} \vert {ψ}_{f}^{′} 〉 ,$$

are, respectively, monotonically decreasing and increasing functions of time (from θ(0) to θ(τ)). The second statement (ii) can be assessed by realizing that [symbol] ψ′(t)|\dot{ψ}′(t) [symbol] =0, which is the transversality condition of Eq. 5 ( [symbol] ψ′(t)|H′_{c}(t)|ψ′(t) [symbol] =i [symbol] ψ′(t)|\dot{ψ}′(t) [symbol] =0,) and guarantees the minimization of the protocol time τ.

The role of the v_{z}(t) can be elucidated by noting that, due to the structure of the Hamiltonian in Eq. 6, 2[ΔH′_{c}(t)]²=tr[H′_{c}²(t)]=tr[H_{c}²(t)], where the last equality follows from the cyclic property of the trace. This property allows writing

$${v}_{z} ( t ) = \sqrt{tr [ {H}_{c}^{2} ( t ) ] / 2} = ‖ {H}_{c} ( t ) ‖ ,$$

which establishes a clear-cut relation between the velocity v_{z}(t) and the Hilbert-Schmidt (or Frobenius) norm of the control Hamiltonian, also known as the energy resource of the control. In this respect, by equating Eq. 2 and Eq. 4, ∫₀^{τ}v_{z}(t)dt=arc cos| [symbol] ψᵢ|ψ′_{f} [symbol] | is obtained.

In examples, the energy disposal of the control is held constant at a value v_{z} non-dependent on time. This condition allows finding an equation for the protocol time τ. By equating Eq. 2 and Eq. 4, the protocol time τ is found by Eq. 8:

$$τ = \frac{1}{{v}_{z}} arccos \sqrt{{ℱ}_{0}} , \qquad Eq . 8$$

where [symbol] ₀≡| [symbol] ψᵢ|ψ′_{f} [symbol] ² is the fidelity of the process dictated solely by the drift Hamiltonian. Equation Eq. 8 represents an alternative expression for Bhattacharyya's quantum speed limit written in the interaction picture. In particular, in the absence of a drift Hamiltonian, [symbol] ₀ can be expressed as [symbol] ₀=| [symbol] ψᵢ|ψ_{f} [symbol] |², and then Eq. 8 coincides with the Mandelstam-Tamm (MT) bound, i.e.,

$${τ}_{M T} = \frac{1}{{v}_{z}} arccos \vert 〈 {ψ}_{i} \vert {ψ}_{f} 〉 \vert . \qquad Eq . 9$$

A further condition may be imposed, such that the energy disposal of the control is held constant at a maximum attainable value, i.e., v_{z}(t)=v_{zMAX}. This condition allows minimizing the protocol time τ, and finding an equation for the protocol time τ_{MIN}. By equating Eq. 2 and Eq. 4 τ_{MIN} is found by Eq. 8_min:

$${τ}_{MIN} = \frac{1}{{v}_{z max}} arccos \sqrt{{ℱ}_{0}} , \qquad Eq . 8 \_min$$

The protocol time τ may be either smaller or larger than τ_{MT} depending on the fidelity of the process dictated by the drift Hamiltonian. Specifically, comparing Eq. 8 and Eq. 9 yields Eq. 10: τ [symbol] τ_{MT} if | [symbol] ψᵢ|ψ_{f} [symbol] |² [symbol] [symbol] ₀.

If the evolution dictated by the drift Hamiltonian brings the initial state closer to the final state in a time τ, then it represents a “favorable wind” and τ<τ_{MT}. Contrarily, if the drift Hamiltonian takes the initial state away from the final state in a protocol time τ, then it represents an “unfavorable wind” and τ>τ_{MT}. Note, however, that Eq. 8 is a nontrivial function of the energy disposal of the control v_{z}. That is, whether a drift Hamiltonian embodies a favorable or unfavorable wind ultimately depends on the duration of the protocol time τ, which in turn is a function of the energy resource of the control v_{z}. Therefore, a given drift Hamiltonian H₀(t) may represent either a favorable or unfavorable wind depending on the energy resource of the control v_{z}.

In an example, for a N level system with N=2, the above method can be derived as follows. As seen, the quantum Zermelo navigation problem has been recast in an interaction picture of quantum mechanics by writing initial and final states respectively as |ψ′ᵢ [symbol] =|ψᵢ [symbol] and |ψ′_{f} [symbol] = [symbol] ₀^{†}(τ)|ψ_{f} [symbol] , and adopting an approach in the projective Hilbert space [symbol] ( [symbol] _{N}). Now, for the particular case where initial and final states live in a two-dimensional Hilbert space [symbol] ₂, a simple derivation of the control Hamiltonian, H′_{c}(t)= [symbol] ₀^{†}(t)H_{c}(t) [symbol] ₀(t), can be obtained using geometric arguments on the Bloch sphere, as shown in the following paragraphs.

For |ψᵢ [symbol] and |ψ′_{f} [symbol] being initial and target states in the interaction picture of a two-dimensional Hilbert space, these can be represented on the Bloch sphere by the Bloch vectors \vec{n}ᵢ and \vec{n}′_{f}(τ) respectively. Then, a state evolving along a great circle, or a geodesic, subtending the angle, Φ(τ)=arc cos(\vec{n}ᵢ·\vec{n}′_{f}(τ)), will reach the target state |ψ′_{f}(τ) [symbol] in the least time τ provided that the angular velocity on the Bloch sphere \dot{Φ}(t) is the greatest available at any time. Such evolution is dictated by the unitary transformation

$${𝒰}_{c} ( t ) exp ( - i \frac{Φ ( t )}{2} \vec{σ} \cdot {\vec{n}}_{⊥} ( τ ) ) ,$$

where the rotation axis is defined as

$${\vec{n}}_{⊥} ( τ ) = \frac{{\vec{n}}_{i} \times {\vec{n}}_{f}^{′}}{\vert {\vec{n}}_{i} \times {\vec{n}}_{f}^{′} \vert} and \vec{σ}$$

is the vector of Pauli matrices. The Hamiltonian that implements [symbol] _{c}(t) is expressed as expression

$${H}_{c}^{′} ( t ) = \frac{\dot{Φ} ( t )}{2} \vec{σ} \cdot {\vec{n}}_{⊥} ( τ ) , \qquad Exp 9$$

which is traceless, fulfills the transversality condition [symbol] ψ′(t)|\dot{ψ}′(t) [symbol] =0, and has a Hilbert-Schmidt norm

$$‖ {H}_{c}^{′} ( t ) ‖ = \sqrt{tr ( {H}_{c}^{′ 2} ( t ) )} = \sqrt{{\dot{Φ}}^{2} ( t ) / 2} .$$

The control Hamiltonian in the expression Exp 9 can now be written in terms of initial and final states |ψᵢ [symbol] and |ψ′_{f}(τ) [symbol] . For that, a new basis through Gram-Schmidt orthogonalization is defined, {|ψᵢ [symbol] ,|ψ̅′_{f}(τ) [symbol] }. Exp 9 is then multiplied from left and from right by the identity [symbol] =|ψᵢ [symbol] ψᵢ|+|ψ̅′_{f} [symbol] ψ̅′_{f}|, and the traceless, transversality and Hilbert-Schmidt norm conditions are imposed, finding the expression Exp 10:

$${H}_{c}^{′} ( t ) = \frac{i \dot{Φ} ( t )}{2 \sqrt{1 - {s}^{2}}} ( {e}^{- i β} \vert {ψ}_{f}^{′} ( τ ) 〉 〈 {ψ}_{i} \vert - {e}^{- i β} \vert {ψ}_{i} 〉 〈 {ψ}_{f}^{′} ( τ ) \vert )$$

where s and β are defined through [symbol] ψᵢ|ψ′_{f}(τ) [symbol] = [symbol] ψᵢ| [symbol] ₀^{†}(τ)|ψ_{f} [symbol] =se^{iβ}.

Given the form of the time-optimal control Hamiltonian, the protocol time τ is found. The evolution of the state under H(t)=H₀(t)+H_{c}(t) drives the initial state to the target state up to a phase factor, hence | [symbol] ψ_{f}| [symbol] ₀(τ) [symbol] _{c}(τ)|ψᵢ [symbol] |=1 by construction. This relation leads to a closed equation for s and τ:

$$s cos ( \frac{Φ ( τ )}{2} ) + \sqrt{1 - {s}^{2}} sin ( \frac{Φ ( τ )}{2} ) = 1$$

which admits the solution

$$s = cos ( \frac{Φ ( τ )}{2} )$$

A manipulation of this equation allows writing: Φ(τ)=2 arc cos(s)=2 arc cos| [symbol] ψᵢ|ψ′_{f}(τ) [symbol] , and expressing the subtended angle as the integral of the angular velocity, Φ(τ)=∫₀^{τ}\dot{Φ}(t)dt, and defining \dot{Φ}=τ⁻¹∫₀^{τ}\dot{Φ}(t)dt, finally yields

$$τ = \frac{2}{\overline{\dot{Φ}}} arccos \vert 〈 {ψ}_{i} \vert {ψ}_{f}^{′} ( τ ) 〉 \vert .$$

In an example, two states |0(t) [symbol] and |1(t) [symbol] , the diabatic levels, are coupled through a LZ Hamiltonian, expressed as Eq. 11: H_{LZ}(t)=Γ(t)σ_{z}+ωσₓ, (σ_{x,z} being the Pauli operators with σₓ|0(t) [symbol] =|1(t) [symbol] ) characterized by instantaneous adiabatic levels of the system |g(t) [symbol] and |e(t) [symbol] . In Eq. 11, ω represents the coupling between the diabatic levels and is kept constant, and Γ(t) is a piecewise-defined function which is chosen to be either a linear function of time according to

$${Γ}_{linear} ( t ) = 4 ( \frac{t}{τ} - 1 / 2 ) , \qquad Eq . 12 a$$

for 0≤t≤τ, or polynomial function of time: according to

$${Γ}_{poly} ( t ) = {a ( \frac{t}{τ} )}^{2} + b ( \frac{t}{τ} ) - 2 , for 0 \leq t \leq τ , \qquad Eq . 12 b$$

with Γ(t<0)=−2 and Γ(t>τ)=2 in both cases. In Eq. 12b

$$a = {b}^{2} / 32 and b = - 16 - \sqrt{1536} / 2$$

to find a situation with a “nonfavorable wind” (as will be clarified below).

The goal is to design a control protocol that drives the system in the least time through the anticrossing point in such a way that at the end of the evolution the final state is the adiabatic ground state, i.e., |ψ(τ) [symbol] =|g(τ) [symbol] . The system is initially prepared in the adiabatic ground state |ψ(0) [symbol] =|g(0) [symbol] and, in the absence of a control Hamiltonian, undergoes tunnelling to the excited state |e(t) [symbol] with a finite probability.

Alternatively, under the action of the control Hamiltonian obtained from Eq. 7 and Eq. 8, with

$${H}_{c}^{′} ( t ) = \frac{{iv}_{z} ( t )}{\sqrt{1 - {s}^{2}}} ( {e}^{- β} \vert {ψ}_{f}^{′} 〉 〈 {ψ}_{i} \vert - {e}^{i β} \vert {ψ}_{i} 〉 〈 {ψ}_{f}^{′} \vert ) , \qquad Eq . 7$$

$$τ = \frac{1}{{v}_{z}} arccos \sqrt{{ℱ}_{0}} , \qquad Eq . 8$$

the evolution of the initial adiabatic ground state will reach the target state in the least time and with unit fidelity. Notably, no restriction is imposed on the form of the control Hamiltonian and hence the present disclosure differs from the prior art where a “preset” form of the control Hamiltonian has been optimized at the price of degrading either fidelity or speed.

An example of implementation of the proposed method may comprise the following steps:

Given a drift Hamiltonian H₀(t), initial and final states |ψᵢ [symbol] and |ψ_{f} [symbol] , and the energy resource of the control v_{z}(t), the protocol time τ may be computed recursively by means of Eq. 8, and assuming v_{z}(t)=v_{z}, or according to ∫₀^{τ}v_{z}(t)dt=arc cos| [symbol] ψᵢ|ψ′_{f} [symbol] |, if the energy resource depends on time. This step requires the evaluation of the fidelity [symbol] ₀≡| [symbol] ψᵢ|ψ′_{f} [symbol] |², which in turn entails the computation of |ψ′_{f} [symbol] = [symbol] ₀^{†}(τ)|ψ_{f} [symbol] , where [symbol] ₀(t)= [symbol] exp(−i∫₀^{t}H₀(t₁)dt₁) and [symbol] defines the usual time ordering operator.

Given τ, the control Hamiltonian in the interaction picture may be constructed H′_{c}(t) according to Eq. 7.

Given H′_{c}(t), the initial state |ψᵢ [symbol] may be propagated according to the time-dependent Schrödinger equation,

$$i \frac{d}{dt} \vert ψ ( t ) 〉 = H ( t ) \vert ψ ( t ) 〉 ,$$

where H(t)=H₀(t)+H_{c}(t) and H_{c}(t)= [symbol] ₀(t)H′_{c}(t) [symbol] ₀^{†}(t).

During the propagation any observable of interest may be computed, such as the mean adiabaticity or the cost as exemplified further below. In the specific example of this disclosure, the drift Hamiltonian, H₀(t), is given by Eq. 11 (Eq. 11: H_{LZ}(t)=Γ(t)σ_{z}+ωσₓ) and Eq. 12, and the initial and final states are the instantaneous adiabatic ground states of H₀(t) at t=0 and t=τ respectively. The protocol time τ may be computed recursively using the bisection method with a tolerance tol=10⁻⁵. The initial state |ψᵢ [symbol] may be propagated using the Runge-Kutta method (4th order) with a time step dt=5×10⁻⁶. The evolution of the control Hamiltonian in the Schrödinger picture may be achieved using the same Runge-Kutta method and according to dH_{c}/dt=−i[H₀, H_{c}] (after imposing the condition v_{z}(t)=v_{z}).

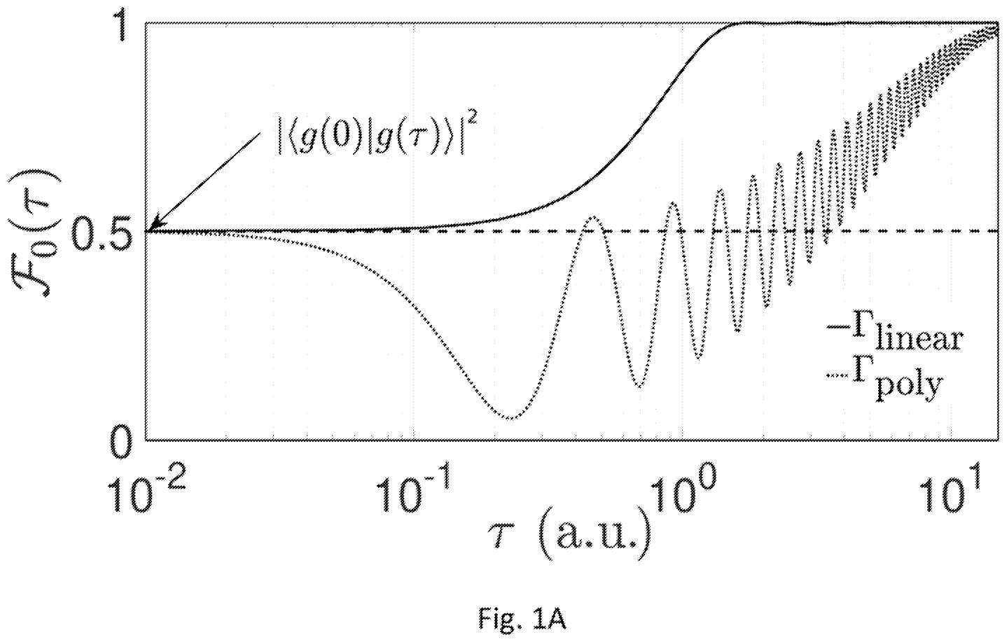

As a way of example, the influence of the drift Hamiltonian in the duration of the control protocol is illustrated in the following. A given drift Hamiltonian H_{LZ}(t) is shown to represent both a favourable and an unfavourable wind depending on the energy resource of the control v_{z}. FIG. 1A represents the Fidelity [symbol] ₀ as a function of τ, Eq. 8, for ω=2 and two different LZ Hamiltonians with Γₗᵢₙₑₐᵣ (solid line) and Γ_{poly} (dotted line). The units a.u. refer to atomic units. The dashed line corresponds to | [symbol] g(0)|g(τ) [symbol] |²=| [symbol] ψᵢ|ψ_{f} [symbol] |². FIG. 1A shows [symbol] ₀ as a function of τ for ω=2, either for Γₗᵢₙₑₐᵣ or Γ_{poly}. In the figure, the regimes where the top and bottom inequalities of Eq. 10 (Eq. 10: τ [symbol] τ_{MT} if | [symbol] ψᵢ|ψ_{f} [symbol] |² [symbol] [symbol] ₀) are fulfilled can be readily identified. This can be verified in FIG. 1B representing the duration of the protocol time τ as a function of the energy resource of the control v_{z} for the same settings as in FIG. 1A, where a.u. refers to atomic units. Both regimes in Eq. 10 can be identified depending on the energy resource of the control for Γ_{poly}. Contrarily, for Γₗᵢₙₑₐᵣ the LZ Hamiltonian always acts as a favourable wind. FIG. 1B shows the protocol time τ drawn as a function of the energy resource of the control v_{z}. For large values of v_{z}, the drift Hamiltonian (no matter whether it is favorable or unfavourable) is irrelevant, and thus τ˜τ_{MT}. For lower values of v_{z}, however, Γ_{poly} may represent a “non-favourable wind” and, hence, delay the arrival of the initial state to the target state as compared to cases with a “favourable wind” (Γₗᵢₙₑₐᵣ) or no wind. For slow enough processes, the drift Hamiltonian prevails over the control field and therefore the protocol time τ becomes always smaller than the MT bound, τ_{MT}, which diverges as v_{z}→0. This is shown in the following:

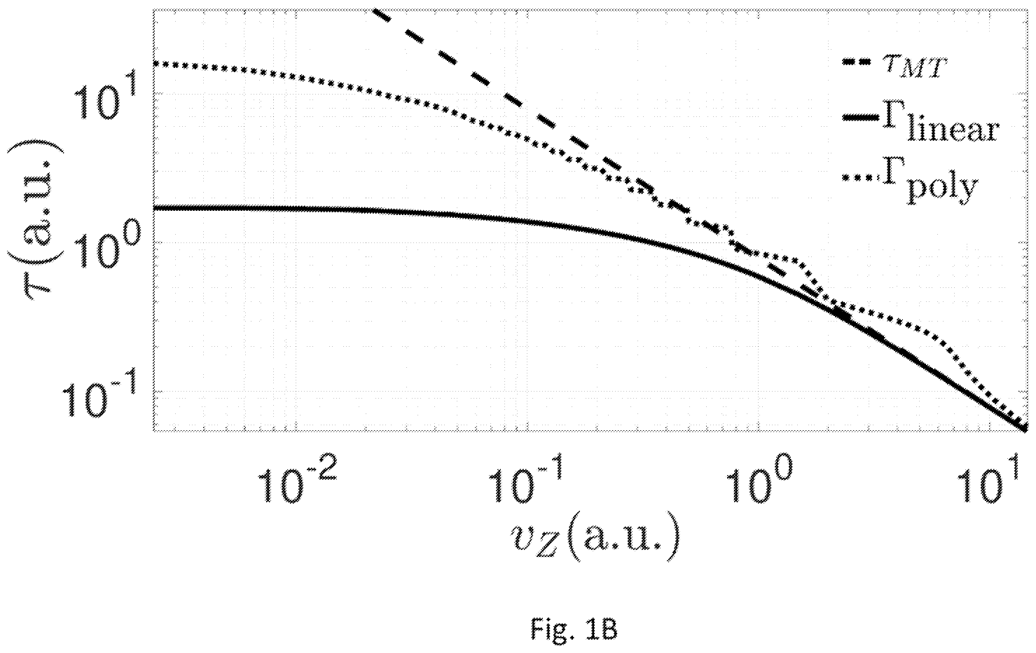

FIG. 2 represents the protocol time, τ, in the presence (solid lines) and in the absence (dashed lines) of the drift Hamiltonian H_{LZ} with Γₗᵢₙₑₐᵣ. In the example of FIG. 2, the drift Hamiltonian H₀ is the drift Hamiltonian in Landau-Zener model (i.e., H₀=H_{LZ}). These results are presented as a function of the energy disposal of the control, v_{z}, and for different values of the coupling constant, ω={0,5,15}.

The FIG. 2 shows the protocol time τ as a function of the energy resource of the control, v_{z}, for three different values of the coupling constant ω={0,5,15}. Solid lines correspond to Eq. 8 and dashed lines and correspond to Eq. 9. FIG. 2 is an example of the top inequality in Eq. 10, revealing how H_{LZ} with Γₗᵢₙₑₐᵣ acts always as a favourable ‘tail wind’ in the search for the target state |g(τ) [symbol] . In the absence of a drift Hamiltonian, the control is the only driving force during the course of the protocol and hence its duration coincides with the MT bound, which according to Eq. 9 is inversely proportional to the energy disposal of the control v_{z}. In the presence of H_{LZ}, the evolution of the system is expected to be roughly independent of the control for small enough values of v_{z} (note the asymptotic behavior of the solid lines for v_{z}≲0.1). An exception occurs for ω=0. In this limit the instantaneous diabatic and adiabatic levels coincide and a level crossing at τ/2 induces an exchange of roles between ground and excited states, i.e., [symbol] =0. Furthermore, since initial and final states |g(0) [symbol] and |g(τ) [symbol] are eigenstates of H_{LZ}(t), the drift Hamiltonian does not exert any force on them and the protocol time reduces again to τ_{MT}, which for orthogonal initial and target states reads τ=τ_{MT}=π/2v_{z}. In general, for finite values of ω the protocol time τ is smaller than τ_{MT} and only at very large values of v_{z}, i.e., when the role of the drift Hamiltonian is negligible in front of the control Hamiltonian, these differences tend to vanish.

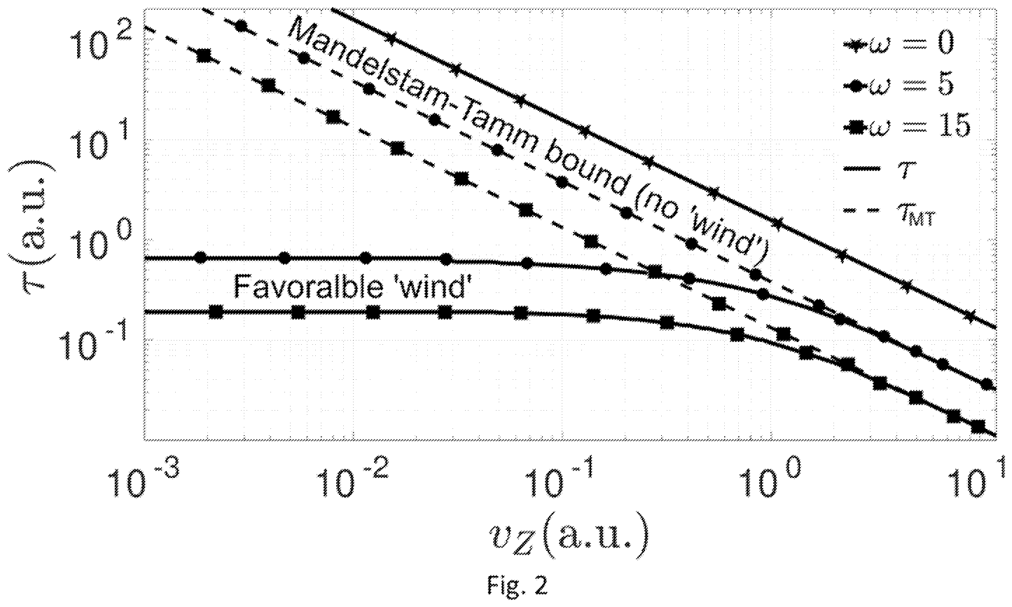

Importantly, no matter how high the energy disposal of the control (v_{z}) is, the mean energy of the system, [symbol] E [symbol] = [symbol] ψ(t)|H_{LZ}(t)|ψ(t) [symbol] , remains well bounded and close to the adiabatic evolution path. FIG. 3 represents the evolution of the energy of the system [symbol] E [symbol] = [symbol] ψ(t)|H_{LZ}(t)|ψ(t) [symbol] for all possible values of v_{z} (solid line) and for ω=0 (left figure) and ω=1 (right figure). The adiabatic energies of the drift Hamiltonian H_{LZ} are illustrated in dotted lines as a reference. The fact that the mean energy of the system, [symbol] E [symbol] = [symbol] ψ(t)|H_{LZ}(t)|ψ(t) [symbol] , remains well bounded and close to the adiabatic evolution path is shown in FIG. 3 in the cases of ω=0 (where [symbol] E [symbol] is independent of v_{z}) and ω=1 (where the solid line spans all possible values of v_{z}).

In some examples of this disclosure, the mean adiabaticity of the overall control process of the dynamics dictated by the control protocol may be computed, as

$$\overline{𝒜} = \frac{1}{τ} {\int }_{0}^{τ} 𝒜 ( t ) dt , where 𝒜 ( t ) = {\vert 〈 g ( t ) \vert ψ ( t ) 〉 \vert}^{2} \qquad Eq . 13$$

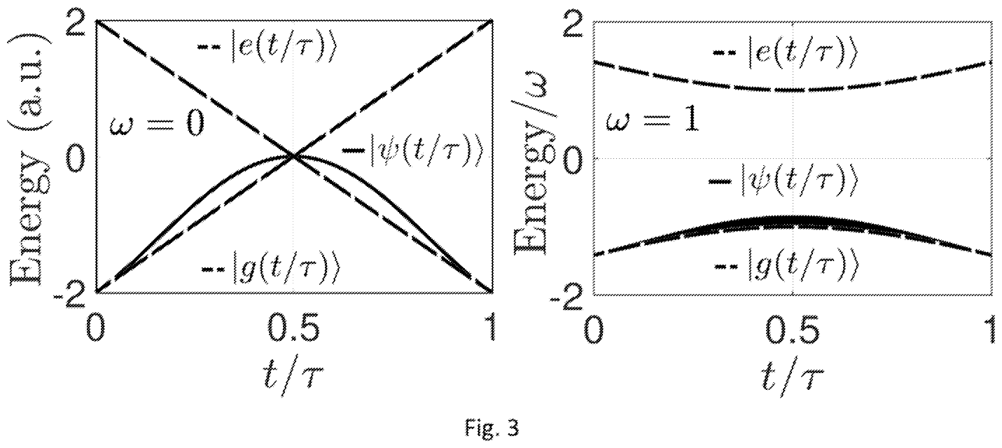

quantifies how close the evolved state of the system is to the instantaneous ground state of H_{LZ}(t). FIG. 4 represents the time-averaged adiabaticity [symbol] , Eq. 13, as a function of τ for Γₗᵢₙₑₐᵣ and different values of the coupling constant ω. Note that the minimum adiabaticity occurs at ω=0, where the level crossing induces an exchange of roles between ground and excited states.

FIG. 4 shows [symbol] as a function of τ for different values of the coupling constant ω. The minimum adiabaticity is expected at ω=0, where the level crossing induces an exchange of roles between ground and excited states. In this limit, Eq. 7 and Eq. 8 can be solved analytically and yield [symbol] ₘᵢₙ≈0.82 independently of the energy resource of the control.

The fact that [symbol] ₘᵢₙ≈0.82 is shown in the following derivation: An analytical solution to Eq. 7 and Eq. 8 is derived for the case where the system is immersed in a drift Hamiltonian of the form: H_{LZ}(t)=Γₗᵢₙₑₐᵣ(t)σ_{z}, and initial and target states are respectively |ψᵢ [symbol] =|g(t=0) [symbol] =|0(t=0) [symbol] and |ψ_{f} [symbol] =|g(t=τ) [symbol] =|1(t=τ) [symbol] . The time-evolution operator associated to H_{LZ}(t) may be written as:

$${𝒰}_{LZ} ( t ) = exp ( - i {σ}_{z} {\int }_{0}^{t} {Γ}_{linear} ( {t}^{′} ) {dt}^{′} ) = exp ( - i {σ}_{z} 2 t ( \frac{t}{τ} - 1 ) ) = exp ( - i {σ}_{z} Λ ( t ) ) . ⅆ$$

This unitary operator allows findings=| [symbol] ψᵢ| [symbol] _{LZ}^{†}(τ)|ψ_{f} [symbol] |=0, and bearing in mind the functional form of the control Hamiltonian of Eq. 7, this yields: H′_{c}(t)=v_{z}σ_{y}.

In the Schrödinger picture, the above equation reads H_{c}(t)= [symbol] _{LZ}(t)H′_{c}(t) [symbol] _{LZ}^{†}(t)=v_{z} exp(−iσ_{z}Λ(t))σ_{y} exp(iσ_{z}Λ(t))=v_{z}(cos(1Λ(t))σ_{y}−sin(2Λ(t))σₓ), where in the last equality the commutation relations of the Pauli matrices are considered. Given the above control Hamiltonian, the dynamics of the system can be determined by an expression Exp 3: |ψ(t) [symbol] = [symbol] _{LZ}(t) [symbol] _{c}(t)|ψᵢ) [symbol] =exp(−iσ_{z}Λ(t))exp(−iσ_{y}∫₀^{t}v_{z}(t′)dt′)|ψᵢ [symbol] =exp(−iσ_{z}Λ(t))exp(−iσ_{y}v_{z}t)|ψᵢ [symbol] .

Notice that in the last equality the ‘full throttle’ condition v_{z}(t)=v_{z} has been considered. Given the above result, an analytical expression of the adiabaticity [symbol] (t)=| [symbol] g(t)|ψ(t) [symbol] |² is sought. For that, it is to be noted that the instantaneous adiabatic ground state evolves as an expression Exp 4:

$$\vert g ( t ) 〉 = \{ \begin{matrix}{𝒰}_{LZ} ( t ) \vert 0 〉 & 0 \leq t \leq τ / 2 , \\ {𝒰}_{LZ} ( t ) {𝒰}_{LZ} ( τ / 2 ) \vert 1 〉 & τ / 2 \leq t \leq τ ,\end{matrix}$$

where |0 [symbol] and |1 [symbol] are the ground and excited states at t=0, respectively. Using the expressions Exp 3 and Exp 4, the adiabaticity can be cast as the following expression:

$$𝒜 ( t ) = \{ \begin{matrix}{\vert 〈 0 \vert {𝒰}_{LZ}^{†} ( t ) \vert ψ ( t ) 〉 \vert}^{2} = {cos}^{2} ( \frac{π}{2} \frac{t}{τ} ) & 0 \leq t \leq τ / 2 \\ {\vert 〈 1 \vert {𝒰}_{LZ}^{†} ( t ) \vert ψ ( t ) 〉 \vert}^{2} = {sin}^{2} ( \frac{π}{2} \frac{t}{τ} ) & τ / 2 \leq t \leq τ\end{matrix}$$

where τ=π/2v_{z}. Finally, the mean adiabaticity can be written as

$$\overline{𝒜} = \frac{1}{τ} {\int }_{0}^{τ} 𝒜 ( t ) dt = \frac{1}{τ} {\int }_{0}^{τ / 2} {cos}^{2} ( \frac{π}{2} \frac{t}{τ} ) dt + \frac{1}{τ} {\int }_{τ / 2}^{τ} {sin}^{2} ( \frac{π}{2} \frac{t}{τ} ) dt = \frac{2 + π}{2 π} \approx 0.82 .$$

Following in FIG. 4, by increasing the value of the coupling constant ω, the resulting dynamics are more and more adiabatic, with [symbol] showing an asymptotic restoring of full adiabaticity for slow processes. For ω≥10, the resulting dynamics are adiabatic within an error less than 0.1%. These results indicate that quantum systems in the form of a LZ type Hamiltonian can be maneuvered at the quantum speed limit in a quasi-adiabatic manner without imposing a preset form of the control Hamiltonian. A relevant question may then be how the proposed control scheme compares to transitionless driving, where the socalled counterdiabatic (CD) field, H_{CD}(t), is designed in such a way that the system is driven precisely through the adiabatic manifold of the drift Hamiltonian (i.e., [symbol] _{CD}=1).

The energetic cost of implementing the control protocol of the present disclosure and the energetic cost of implementing the CD driving field may be evaluated. The cost is defined herein by Campbell and coworkers and the Frobenius norm of the total Hamiltonian is used to define the cost of the control protocol as

$${𝒞}_{T} = \frac{1}{τ} {\int }_{0}^{τ} ‖ H ( t ) ‖ dt , where ‖ H ( t ) ‖ = \sqrt{tr [ {H}^{2} ) t ] / 2} and H ( t ) \qquad Eq . 14$$

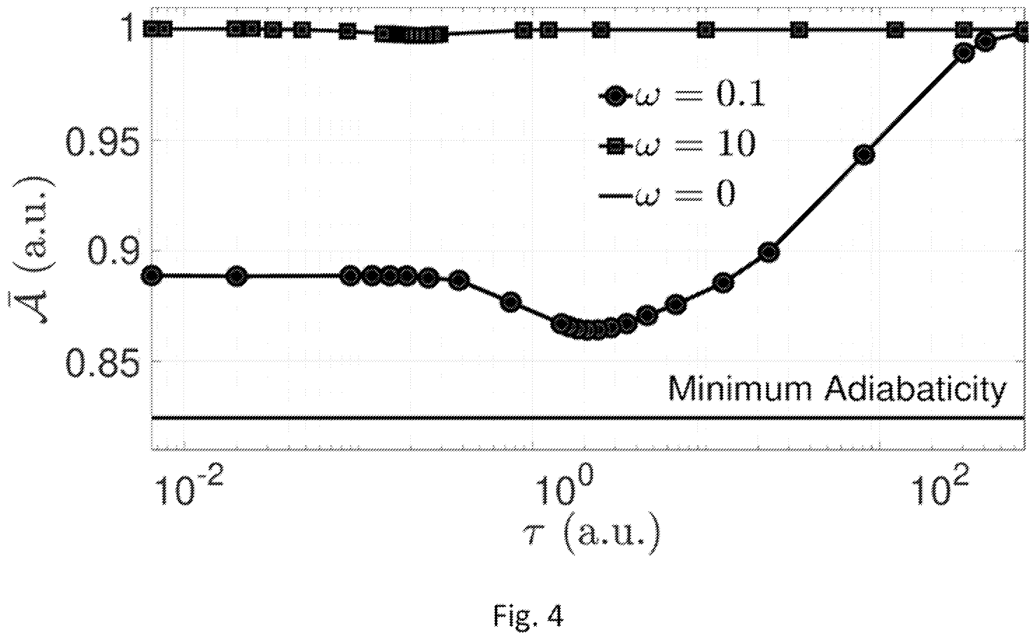

is the total Hamiltonian including the drift and control fields. FIG. 5 represents the cost (in atomic units, a.u.) of implementing the proposed protocol of this disclosure (solid line with circle marker and solid line with squared markers) and the counterdiabatic, CD, (solid line with no marker and solid line with star markers) protocols calculated through Eq. 14. [symbol] _{LZ} (dashed lines) denotes the cost of implementing solely the LZ Hamiltonian. As shown in FIG. 5, for very low speed processes the cost of implementing both protocols converge to the cost of implementing solely the LZ Hamiltonian [symbol] _{LZ}=(1/τ)∫₀^{τ}∥H_{LZ}(t)∥dt. Imposing full adiabaticity at higher speeds, however, may result in being orders of magnitude more expensive than assuming a slightly nonadiabatic evolution. For example, at ω=10, implementing a counterdiabatic driving field can be as costly as ×100 the cost of implementing our control protocol, which is already 99.9% adiabatic. At lower coupling constants and high speeds, the cost difference between the two protocols increases even further while the adiabaticity error in the proposed protocol is always kept below 20%. Remarkably, for ω=0, the CD driving field does not bring the system to the target state. This is in contrast to the proposed protocol, which reaches the final state through a highly adiabatic path. It is clear from the FIGS. 4 and 5 that imposing full adiabaticity at high speeds may result in being orders of magnitude more expensive than assuming a slightly nonadiabatic evolution.

For the above example, a detailed comparison of the matrix elements of H_{c}(t) and H_{CD}(t) is given in the following paragraphs. It is to be noted that the practical implementation of H_{c}(t) and H_{CD}(t) ultimately depends on the physical system under consideration. The following paragraphs describe the practical implementation of H_{c}(t) for a spin ½ in a time-varying magnetic field and a Bose Einstein condensate in a time dependent optical lattice, both immersed in a LZ type Hamiltonian.

The most general form of the control Hamiltonian that drives an initial state into a target state under the influence of H_{LZ} can be written as Exp 5: H_{c}(t)=μ(t)σₓ−γ(t)σ_{y}+ϵ(t)σ_{z}.

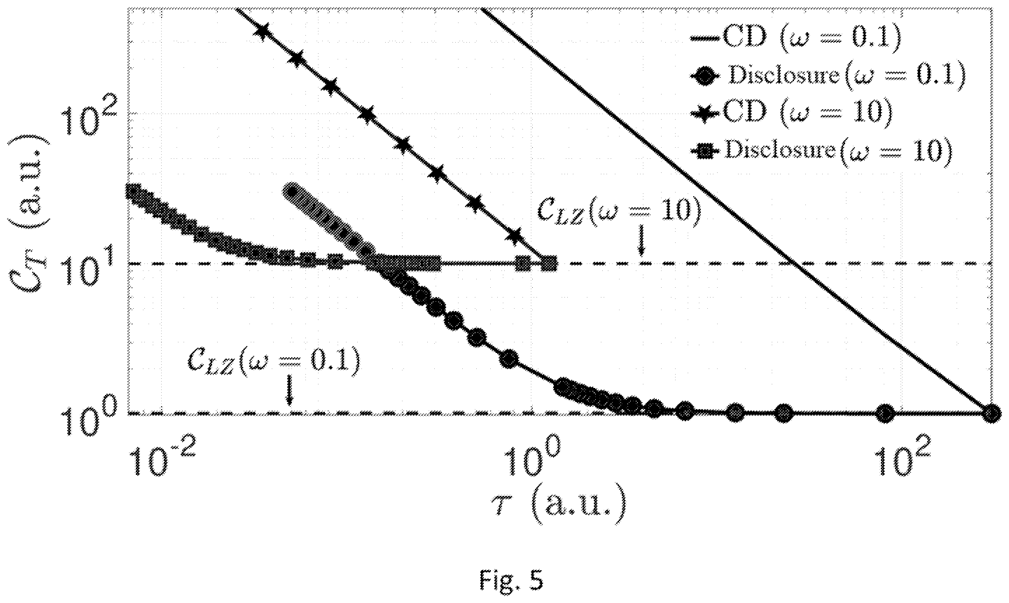

For the particular case of ω=0.1 and Γₗᵢₙₑₐᵣ, the time-dependence of the functions μ(t), γ(t) and ϵ(t) is shown in FIG. 6 for different values of the least time τ (this is to say for different values of the energy resource of the control v_{z}). For the sake of comparison, we also plot the corresponding counterdiabatic term H_{CD}(t), that for the LZ model with Γₗᵢₙₑₐᵣ(t), takes the specific form as in the expression

$${H}_{CD} ( t ) = - \frac{{\dot{Γ}}_{linear} ( t ) ω}{2 ( {ω}^{2} + {Γ}_{linear}^{2} ( t ) )} {σ}_{y} ,$$

where \dot{Γ}ₗᵢₙₑₐᵣ(t)=∂ₜΓₗᵢₙₑₐᵣ(t)=4/τ, and the coefficients of σₓ and σ_{z} are zero. In the three panels of FIG. 6, the coefficients are either antisymmetric (the case of ϵ(t)) or symmetric (the case of μ(t) and γ(t)) with respect to the midpoint of the time axis (at t=τ/2) where an avoided crossing of the adiabatic levels occurs with an energy gap 2ω. The coefficients in Exp 5 tend to zero progressively as τ increases (i.e. the energy resource of the control decreases). This behavior indicates that the control is less relevant at low speeds, as expected. Moreover, notice that the three quantities, μ, γ and ϵ, are connected through the Zermelo velocity, v_{z}={square root over (tr(H_{c}²(t))/2)}, which can be written as Expression Exp 7: v_{z}(t)=\sqrt{μ²(t)+γ²(t)+ϵ²(t)}. H_{c}²(t)=(μ²(t)+γ²(t)+ϵ²(t)) [symbol] has been used and thus tr(H_{c}²(t))=2(μ²(t)+γ²(t)+ϵ²(t)). Expression Exp 7 establishes a connection between the three panels of FIG. 6 for the control Hamiltonian. Regarding the counterdiabatic term in Exp 6, it is relevant to highlight the fact that it takes considerably higher values than the corresponding control term of the control protocol Hamiltonian of this disclosure, as can be seen in the first panel.

The practical implementation of the above control Hamiltonian depends on the system under consideration. As a first example, consider the situation where a spin ½ is immersed in a time-varying magnetic field \vec{B}(t). The spin-field interaction Hamiltonian can be written as the Expression

$$Exp 8 : {H}_{s} ( t ) = - ξ \vec{B} ( t ) \cdot \vec{S} = - \frac{ξ}{2} ( {B}_{x} ( t ) {σ}_{x} + {B}_{y} ( t ) {σ}_{y} + {B}_{z} ( t ) {σ}_{z} ) ,$$

where ξ=gq/2m, with g the g-factor and m and q the mass and the charge of the particle, respectively. Comparing Exp 5 and Exp 8, a one-to-one correspondence between the components of the magnetic field and the control Hamiltonian are established, resulting in

$${B}_{x} ( t ) = - \frac{2 μ ( t )}{ξ} , {B}_{y} ( t ) = \frac{2 γ ( t )}{ξ} , {B}_{z} ( t ) = - \frac{2 ϵ ( t )}{ξ} .$$

As a second example, considering a Bose-Einstein condensate (BEC) in an optical lattice, under appropriate conditions the wavef unction of the BEC in the periodic potential of the optical lattice can be approximated by considering only the two lowest energy bands, which exhibit an avoided crossing at the edge of the first Brillouin zone (see FIG. 3) and thus realize a Landau-Zener Hamiltonian of the form in Eq. 11 (Eq. 11: H_{LZ}(t)=Γ(t)σ_{z}+ωσₓ) where terms accompanying σ_{z} and σₓ can be controlled through the quasimomentum p and the depth V₀ of the optical lattice, respectively. To make a given evolution of a two-level system introducing the control Hamiltonian of Exp 5, (H_{c}(t)=μ(t)σₓ−γ(t)σ_{y}+ϵ(t)σ_{z}), an interaction term corresponding to a σ_{y} Pauli matrix is added. The interaction term corresponding to a σ_{y} may be implemented by introducing an additional interaction into the system, for example, through an extra laser or microwave field. In the case of atoms in an optical lattice, σ_{y} components can be realized by adding a second optical lattice shifted with respect to the first by d_{L}/4, where d_{L} is the lattice spacing. The interaction term corresponding to a σ_{y} may be implemented through an appropriate transformation Γ→Γ′ and ω→ω′, such that no extra field is necessary. This transformation, which may be independent of the physical system under consideration (and could be considered as well for the spin in a magnetic field case), means that the resulting protocol is intrinsically more stable, as there will be no problems associated, for example, with phase fluctuations between the fields.

In some examples, in the quantum system according to this disclosure:
the one or more drift fields comprise at least an optical lattice, the optical lattice comprising one or more laser sources;
the one or more particles comprise one or more atoms trapped in the optical lattice and defined by a time dependent Hermitian two-level drift Hamiltonian H₀(t)=Γ_{zo}(t)σ_{z} and the one more atoms in an initial quantum state |ψᵢ [symbol] defined as the ground (eigen) state of the drift Hamiltonian H₀(t) at time t=0;
the at least one field generator comprises at least one or more lasers sources configured to drive the one or more atoms trapped in the optical lattice to a final quantum state |ψ_{f} [symbol] defined as the ground (eigen) state of the drift Hamiltonian H₀(t) at time t=τ, wherein the at least one or more lasers sources are characterized in that

H(t)=H₀(t)+H_{c}(t)=Γ_{zo}(t)σ_{z}+(Γₓ(t)σₓ+Γ_{y}(t)σ_{y}+Γ_{z}(t)σ_{z}),
with a control protocol Hamiltonian H_{c}(t)=Γₓ(t)σₓ+Γ_{y}(t)σ_{y}+Γ_{z}(t)σ_{z}= [symbol] ₀(t)H′_{c}(t) [symbol] ₀^{†}(t); and the method further comprises, before establishing a one-to-one correspondence between the interaction of \vec{F}_{ι} with an N level system, time-evolving the initial state |ψᵢ [symbol] , during the protocol time τ, according to the following time-dependent Schrödinger equation:

$$i \frac{d}{dt} \vert ψ ( t ) 〉 = H ( t ) \vert ψ ( t ) 〉 ,$$

where H(t)=H₀(t)+H_{c}(t),
or equivalently |ψ(t) [symbol] = [symbol] ₀(t) [symbol] _{c}(t)|ψᵢ [symbol] , where i [symbol] _{c}(t)=H′_{c}(t) [symbol] _{c}(t).

In an example, the time-optimal control of a Landau-Zener model system is illustrated by assessing the performance of the control protocol Hamiltonian provided in the present disclosure. In the example, the evolution of a two-level system under a Landau-Zener, LZ, drift Hamiltonian is observed. The two-level system comprises two interacting ½-spin qubits in a drift Hamiltonian of the form: H₀=−ΣⱼJⱼσⱼ⁽¹⁾σⱼ⁽²⁾, where j=x,y,z and Jⱼ represents the coupling between both spins, and where (1) indicates the first spin (½) and (2) indicates the second spin (½). The drift Hamiltonian is diagonal in the Bell states basis, and thus:

$$\begin{matrix}{H}_{0} = - ( {J}_{z} + {J}_{-} ) \vert {Φ}^{+} 〉 〈 {Φ}^{+} \vert - ( {J}_{z} - {J}_{-} ) \vert {Φ}^{-} 〉 〈 {Φ}^{-} \vert \\ + ( {J}_{z} + {J}_{+} ) \vert {Ψ}^{+} 〉 〈 {Ψ}^{+} \vert + ( {J}_{z} + {J}_{+} ) \vert {Ψ}^{-} 〉 〈 {Ψ}^{-} \vert ,\end{matrix}$$

with J_{±}=Jₓ±J_{y}. The aim is to entangle an initially separable state of the form |ψᵢ [symbol] =|0 [symbol] ⊗|1 [symbol] =|01 [symbol] into a final Bell state, |ψ_{f} [symbol] =|Ψ⁺ [symbol] =(|01 [symbol] +|10 [symbol] )/\sqrt{2}, in the minimum possible time. According to Eq. 7, the control Hamiltonian in the Schrödinger picture reads:

$${H}_{c} ( t ) = i \frac{{v}_{z} ( t )}{\sqrt{1 - {s}^{2}}} {𝒰}_{0} ( t ) ( {e}^{- i β} {𝒰}_{0}^{†} ( τ ) \vert {Ψ}^{+} 〉 〈 01 \vert - {e}^{i β} \vert 01 〉 〈 {Ψ}^{+} \vert {𝒰}_{0} ( τ ) ) {𝒰}_{0}^{†} ( t ) ,$$

where [symbol] 01| [symbol] ₀^{†}(τ)|Ψ⁺ [symbol] =se^{iβ}. Using the Bell state basis, the above control Hamiltonian can be rewritten as Expression Exp 1:

$${H}_{c} ( t ) = \frac{1}{\sqrt{2}} \frac{{v}_{z} ( t )}{\sqrt{1 - {s}^{2}}} ( 2 cos Θ \vert {Ψ}^{+} 〉 〈 {Ψ}^{+} \vert +$$

$${e}^{i ( Θ + 2 {J}_{+} t )} \vert {Ψ}^{+} 〉 〈 {Ψ}^{-} \vert + {e}^{- i ( Θ + 2 {J}_{+} t )} \vert {Ψ}^{-} 〉 \text{} 〈 {Ψ}^{+} \vert ) ,$$

$$where$$

$$Θ = \frac{π}{2} - β + ( {J}_{z} - {J}_{+} ) τ .$$

The parameters s and β can be obtained from the overlap [symbol] 01| [symbol] ₀^{†}(τ)|Ψ⁺ [symbol] , which yields:

$$s = \frac{1}{\sqrt{2}} and β = ( {J}_{z} - {J}_{+} ) τ ,$$

and therefore Θ=π/2. The control Hamiltonian in Exp 1 finally reads: Exp 2: H_{c}(t)=iv_{z}(e^{i2J}^{₊}^{t}|Ψ⁺ [symbol] Ψ⁻|−e^{-i2J}^{₊}^{t}|Ψ⁻ [symbol] Ψ⁺|),
where v_{z}(t)=v_{z} has been assumed. The protocol time τ from Eq. 8 then reads:

$$τ = \frac{1}{{v}_{z}} arccos ( \frac{1}{\sqrt{2}} ) , which gives τ = \frac{π}{4 {v}_{z}} .$$

Recasting the Hamiltonian of Exp 2 in the basis {|00 [symbol] , |01 [symbol] , |10 [symbol] , |11 [symbol] }:

$$\begin{matrix}{H}_{c} ( t ) = 2 {v}_{z} sin ( 2 {J}_{+} t ) ( \begin{matrix}0 & 0 & 0 & 0 \\ 0 & - 1 & 0 & 0 \\ 0 & 0 & 1 & 0 \\ 0 & 0 & 0 & 0\end{matrix} ) + 2 {v}_{z} cos ( 2 {J}_{+} t ) ( \begin{matrix}0 & 0 & 0 & 0 \\ 0 & 0 & - i & 0 \\ 0 & i & 0 & 0 \\ 0 & 0 & 0 & 0\end{matrix} ) \\ = {v}_{z} ( sin ( 2 {J}_{+} t ) ( ⊗ {σ}_{z} - {σ}_{z} ⊗ ) + cos ( 2 {J}_{+} t ) ( {σ}_{y} ⊗ {σ}_{x} - {σ}_{x} {⊗}_{y} ) )\end{matrix} .$$

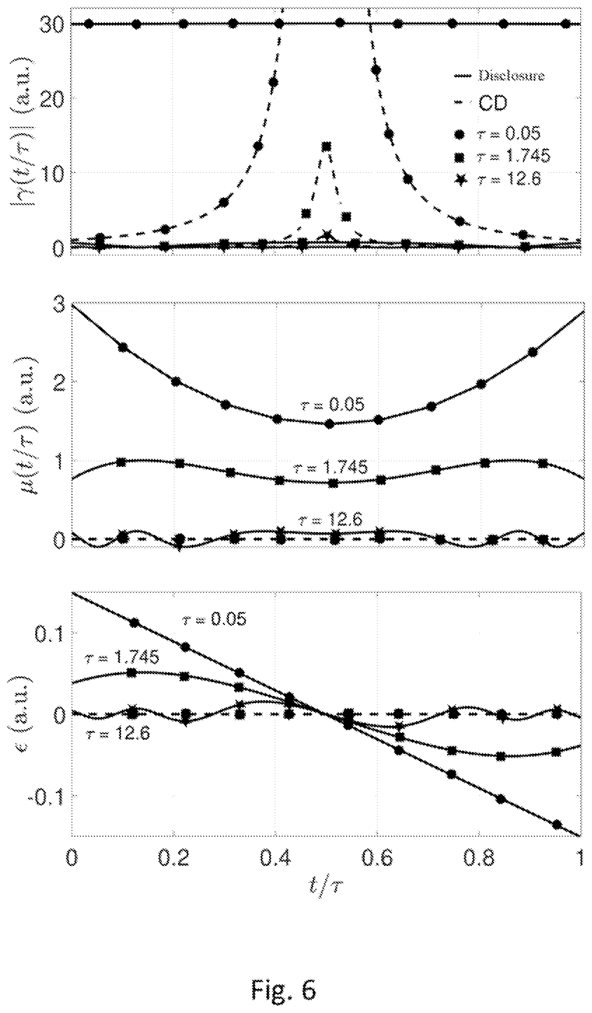

FIG. 7 represents a computer 100 configured to determine a control protocol Hamiltonian for a quantum process of a quantum system. In examples, the computer is as described in the different examples of the present disclosure.

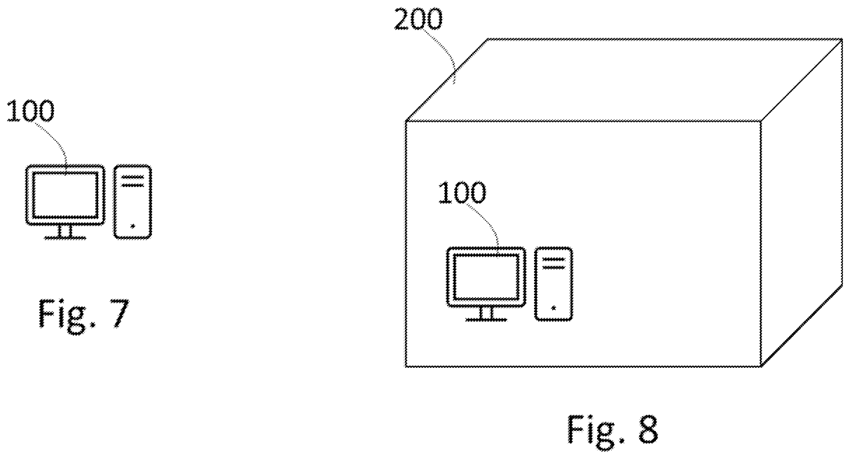

FIG. 8 represents a quantum system 200 comprising the computer 100 of the present disclosure.

Advantageously, as seen, based on a pure geometric derivation in a projective Hilbert space, an “ansatz-free” approach to time-optimal quantum control is provided in the present disclosure. The analysis of this scheme as applied to the Landau-Zener model yielded two important conclusions for maximum speed transformations. First, no “guessed” form of the control Hamiltonian is required for designing a time-optimal control protocol that, along with the action of a time-dependent drift Hamiltonian, drives an initial state to a target state in the least time and with unit fidelity. The solution to the system of Eq. 7 and Eq. 8 can be thus exploited to conceive new, unforeseen, time-optimal control protocols. Second, quasi adiabatic dynamics with less than 0.1% deviation from the full adiabatic path can be attained at the quantum speed limit with an energetic cost that is orders of magnitude lower than the cost of implementing a counterdiabatic CD field. Therefore, the proposed control method lends itself as a “low-cost” alternative to transitionless driving. Overall, the quantum control approach established opens a new avenue in the search for more time- and energy-efficient control protocols.

All of the features disclosed in this specification, all the examples, including any accompanying claims, abstract and drawings, and/or all of the steps of any method or process so disclosed, may be combined in any combination, except combinations where at least some of such features and/or steps are mutually exclusive.

What is claimed is:

1. A computer implemented method to determine a control protocol Hamiltonian for a quantum process, the method comprising:
providing a time dependent Hermitian drift Hamiltonian H₀(t), an initial state |ψᵢ [symbol] , a final state, |ψ_{f} [symbol] , and either a finite energy resource of the control protocol v_{z}(t), or a protocol time τ and a functional form of v_{z}(t) with respect to time t;
iteratively equating an equation expressed as ∫₀^{τ}v_{z}(t)dt=arc cos| [symbol] ψᵢ|ψ′_{f} [symbol] |, wherein, in each iteration, values of either a protocol time τ or values of a finite energy resource of the control protocol v_{z}(t), are modified until both sides of the equation are at least substantially equal; obtaining thereby either a protocol time τ or a finite energy resource of the control protocol v_{z}(t);
constructing a control protocol Hamiltonian in an interaction picture with respect to H₀(t), H′_{c}(t) according to
$${H}_{c}^{′} ( t ) = \frac{i {v}_{z} ( t )}{\sqrt{1 - {s}^{2}}} ( {e}^{- i β} \vert {ψ}_{f}^{′} 〉 〈 {ψ}_{i} \vert - {e}^{i β} \vert {ψ}_{i} 〉 〈 {ψ}_{f}^{′} \vert ) ,$$
where s and β are defined through [symbol] ψᵢ|ψ′_{f}(τ) [symbol] = [symbol] ψᵢ| [symbol] ₀^{†}(τ)|ψ_{f} [symbol] =se^{iβ}, and parameters in the interaction picture represent, each:
s modulus;
β phase;

|ψ′_{f} [symbol] the final state |ψ_{f} [symbol] , in the interaction picture, with |ψ′_{f} [symbol] = [symbol] ₀^{†}(τ)|ψ_{f} [symbol] , where [symbol] ₀(τ)= [symbol] exp(−i∫₀^{τ}H₀(t₁)dt₁) and [symbol] defines a time ordering operator; and
† means conjugate transpose; and
determining the control protocol Hamiltonian in the Schrödinger picture as H_{c}(t)= [symbol] ₀(t)H′_{c}(t) [symbol] ₀^{†}(t).

2. The computer implemented method according to claim 1, further comprising:
time-evolving the initial state |ψᵢ [symbol] , during the protocol time τ, according to the following time-dependent Schrödinger equation:
$$i \frac{d}{dt} \vert ψ ( t ) 〉 = H ( t ) \vert ψ ( t ) 〉 ,$$
where H(t)=H₀(t)+H_{c}(t),
or equivalently |ψ(t) [symbol] = [symbol] ₀(t) [symbol] _{c}(t)|ψᵢ [symbol] , where i [symbol] _{c}(t)=H′_{c}(t) [symbol] _{c}(t).

3. The computer implemented method according to claim 1, where the energy resource of the control protocol v_{z}(t) is provided and assumed independent from time and equal to v_{z}, and wherein computing the protocol time τ is performed by iteratively computing an equation expressed as
$$τ = \frac{1}{{v}_{z}} arccos \vert 〈 {ψ}_{i} \vert {ψ}_{f}^{′} 〉 \vert ,$$
where, in each iteration, values of protocol time τ are modified until both sides of the equation are at least substantially equal.

4. The computer implemented method according to claim 1, wherein computing a protocol time τ or the energy resource of the control protocol v_{z}(t) is performed by:
performing a bisection method with a predefined step dt obtaining a value of τ for each iteration until ∫₀^{τ}v_{z}(t)dt and arc cos| [symbol] ψᵢ|ψ′_{f} [symbol] | are at least substantially equal, wherein substantially equal comprises that ∫₀^{τ}v_{z}(t)dt approximates to arc cos| [symbol] ψᵢ|ψ′_{f} [symbol] | within a tolerance.

5. The computer implemented method according to claim 1, wherein determining the control protocol Hamiltonian in the Schrödinger picture is performed by solving dH_{c}/dt=−i[H₀, H_{c}] and assuming v_{z}(t)=v_{z}.

6. The computer implemented method according to claim 1, further comprising computing any of the following quantities:
a. a unit fidelity of the control process as: [symbol]
=| [symbol] ψ_{f}| [symbol] (τ)|ψᵢ [symbol] |²,
where [symbol] (τ)= [symbol] exp(−i∫₀^{τ}H(t′)dt′), and where [symbol] defines the usual time ordering operator, and H(t)=H₀(t)+H_{c}(t); and/or
b. a cost as:
$${𝒞}_{T} = \frac{1}{τ} {\int }_{0}^{τ} ‖ H ( t ) ‖ dt , where ‖ H ( t ) ‖ = \sqrt{t r [ {H}^{2} ( t ) ] / 2}$$
and H(t) is the total Hamiltonian including the drift and control Hamiltonians; and/or
c. an adiabaticity as:
$${\overline{𝒜} = \frac{1}{τ} {\int }_{0}^{τ} 𝒜 ( t ) dt , where 𝒜 ( t ) = \vert 〈 g ( t ) \vert ψ ( t ) 〉 \vert}^{2}$$
quantifies how close the evolved state of the system is to the instantaneous ground state of H₀(t), where g(t) is the instantaneous ground (eigen) state of H₀(t).

7. The computer implemented method according to claim 1, further comprising:
time-evolving the initial state |ψᵢ [symbol] , during the protocol time τ, according to the following time-dependent Schrödinger equation:
$$i \frac{d}{dt} \vert ψ ( t ) 〉 = H ( t ) \vert ψ ( t ) 〉 ,$$
where H(t)=H₀(t)+H_{c}(t),
or equivalently |ψ(t) [symbol] = [symbol] ₀(t) [symbol] _{c}(t)|ψᵢ [symbol] , where i [symbol] _{c}(t)=H′_{c}(t) [symbol] _{c}(t);
where the energy resource of the control protocol v_{z}(t) is provided and assumed independent from time and equal to v_{z}, and wherein computing the protocol time τ is performed by iteratively computing an equation expressed as
$$τ = \frac{1}{{v}_{z}} arccos \vert 〈 {ψ}_{i} \vert {ψ}_{f}^{′} 〉 \vert ,$$
where, in each iteration, values of protocol time τ are modified until both sides of the equation are at least substantially equal.

8. The computer implemented method according to claim 1, further comprising:
time-evolving the initial state |ψᵢ [symbol] , during the protocol time τ, according to the following time-dependent Schrödinger equation:
$$i \frac{d}{dt} \vert ψ ( t ) 〉 = H ( t ) \vert ψ ( t ) 〉 ,$$
where H(t)=H₀(t)+H_{c}(t),
or equivalently |ψ(t) [symbol] = [symbol] ₀(t) [symbol] _{c}(t)|ψᵢ [symbol] , where i [symbol] _{c}(t)=H′_{c}(t) [symbol] _{c}(t); and
wherein computing a protocol time τ or the energy resource of the control protocol v_{z}(t) is performed by performing a bisection method with a predefined step dt obtaining a value of τ for each iteration until ∫₀^{τ}v_{z}(t)dt and arc cos| [symbol] ψᵢ|ψ′_{f} [symbol] | are at least substantially equal, wherein substantially equal comprises that ∫₀^{τ}v_{z}(t)dt approximates to arc cos| [symbol] ψᵢ|ψ′_{f} [symbol] | within a tolerance.

9. The computer implemented method according to claim 1, further comprising:
establishing a one-to-one correspondence between the interaction of one or more fields \vec{F}_{ι} with an N level system and the control protocol Hamiltonian H_{c}(t); wherein, when N is 2, the control protocol Hamiltonian comprises the interaction of at least one field \vec{F}_{ι} with the 2-level system and the control protocol Hamiltonian, and the one-to-one correspondence is established as:
$${H}_{c} ( t ) = {\sum }_{i} ( \vec{{F}_{ι}} ( t ) \cdot \vec{σ} ) = {\sum }_{i} ( {μ}_{i} ( t ) {σ}_{x} - {γ}_{i} ( t ) {σ}_{y} + {ϵ}_{i} ( t ) {σ}_{z} ) ;$$
where Σᵢ(\vec{F}_{ι}(t)·\vec{σ})=Σᵢ(μᵢ(t)σₓ−γᵢ(t)σ_{y}+ϵᵢ(t)σ_{z}) represents the sum of the possible fields \vec{F}_{ι}, where \vec{F}=Σᵢ(\vec{F}_{ι}(t)), and \vec{σ}=(σₓ, σ_{y}, σ_{z}), is the vector of Pauli matrices corresponding to the system.

10. The computer implemented method according to claim 1, further comprising:
establishing a one-to-one correspondence between a magnetic field \vec{B}(t) with a particle with 2 independent quantum states characterized by g being the g-factor, m being the mass of the particle and q being the charge of the particle, and the control protocol Hamiltonian being:
$$H ( t ) = {H}_{0} ( t ) + {H}_{c} ( t ) = - ξ \vec{B} ( t ) \cdot \vec{S} = - \frac{ξ}{2} ( {B}_{x} ( t ) {σ}_{x} + - {B}_{y} ( t ) {σ}_{y} + {B}_{z} ( t ) {σ}_{z} ) ;$$
wherein the components of \vec{B}(t) are expressed as:
$${B}_{x} ( t ) = - \frac{2 μ ( t )}{ξ} , {B}_{y} ( t ) = \frac{2 γ ( t )}{ξ} , {B}_{z} ( t ) = - \frac{2 ϵ ( t )}{ξ} ;$$
$$ξ = gq / 2 m ; and$$
$$where \vec{B} ( t ) = {\sum }_{i} ( \vec{{B}_{ι}} ( t ) ) .$$

11. The computer implemented method according to claim 1, further comprising:
establishing a one-to-one correspondence between an optical lattice \vec{Γ}(t) with a particle with 2 independent quantum states characterized by g being the g-factor, m being the mass of the particle and q being the charge of the particle, and the control protocol Hamiltonian being:
$$H ( t ) = {H}_{0} ( t ) + {H}_{c} ( t ) = - ξ \vec{Γ} ( t ) \cdot \vec{S} = - \frac{ξ}{2} ( {Γ}_{x} ( t ) {σ}_{x} + - {Γ}_{y} ( t ) {σ}_{y} + {Γ}_{z} ( t ) {σ}_{z} ) ;$$
where the components of \vec{Γ}(t) are expressed as:
$${Γ}_{x} ( t ) = - \frac{2 μ ( t )}{ξ} , {Γ}_{y} ( t ) = \frac{2 γ ( t )}{ξ} , {Γ}_{z} ( t ) = - \frac{2 ϵ ( t )}{ξ} ;$$
ξ=gq/2m; and
where \vec{Γ}(t)=Σᵢ(\vec{Γ}_{ι}(t)).

12. A computer system comprising:
a processor; and
a memory that stores program code configured to cause the processor to determine a control protocol Hamiltonian for a quantum process, by:
providing a time dependent Hermitian drift Hamiltonian H₀(t), an initial state |ψᵢ [symbol] , a final state, |ψ_{f} [symbol] , and either a finite energy resource of the control protocol v_{z}(t), or a protocol time τ and a functional form of v_{z}(t) with respect to time t;
iteratively equating an equation expressed as ∫₀^{τ}v_{z}(t)dt=arc cos| [symbol] ψᵢ|ψ′_{f} [symbol] |, wherein, in each iteration, values of either a protocol time τ or values of a finite energy resource of the control protocol v_{z}(t), are modified until both sides of the equation are at least substantially equal; obtaining thereby either a protocol time τ or a finite energy resource of the control protocol v_{z}(t);
constructing a control protocol Hamiltonian in an interaction picture with respect to H₀(t), H′_{c}(t) according to
$${H}_{c}^{′} ( t ) = \frac{i {v}_{z} ( t )}{\sqrt{1 - {s}^{2}}} ( {e}^{- i β} \vert {ψ}_{f}^{′} 〉 〈 {ψ}_{i} \vert - {e}^{i β} \vert {ψ}_{i} 〉 〈 {ψ}_{f}^{′} \vert )$$
where s and β are defined through [symbol] ψᵢ|ψ′_{f}(τ) [symbol] = [symbol] ψᵢ| [symbol] ₀^{†}(τ)|ψ_{f} [symbol] =se^{iβ}, and parameters in the interaction picture represent, each:
s modulus;
β phase;

|ψ′_{f} [symbol] the final state |ψ_{f} [symbol] , in the interaction picture, with |ψ′_{f} [symbol] = [symbol] ₀^{†}(τ)|ψ_{f} [symbol] , where [symbol] ₀(τ)= [symbol] exp(−i∫₀^{τ}H₀(t₁)dt₁) and [symbol] defines a time ordering operator; and
† means conjugate transpose; and
determining the control protocol Hamiltonian in the Schrödinger picture as H_{c}(t)= [symbol] ₀(t)H′_{c}(t) [symbol] ₀^{†}(t).

13. The computer system of claim 12, further configured to:
time-evolve the initial state |\dot{ψ}ᵢ [symbol] , during the protocol time τ, according to the following time-dependent Schrödinger equation:
$$i \frac{d}{dt} \vert ψ ( t ) 〉 = H ( t ) \vert ψ ( t ) 〉 ,$$
where H(t)=H₀(t)+H_{c}(t),
or equivalently |ψ(t) [symbol] = [symbol] ₀(t) [symbol] _{c}(t)|ψᵢ [symbol] , where i [symbol] _{c}(t)=H′_{c}(t) [symbol] _{c}(t).

14. The computer system of claim 12, further configured to:
establish a one-to-one correspondence between the interaction of one or more fields \vec{F}_{ι} with an N level system and the control protocol Hamiltonian H_{c}(t); wherein, when N is 2, the control protocol Hamiltonian comprises the interaction of at least one field \vec{F}_{ι} with the 2-level system and the control protocol Hamiltonian, and the one-to-one correspondence is established as:
$${H}_{c} ( t ) = {\sum }_{i} ( \vec{{F}_{ι}} ( t ) \cdot \vec{σ} ) = {\sum }_{i} ( {μ}_{i} ( t ) {σ}_{x} - {γ}_{i} ( t ) {σ}_{y} + {ϵ}_{i} ( t ) {σ}_{z} ) ;$$
where Σᵢ(\vec{F}_{ι}(t)·\vec{σ})=Σᵢ(μᵢ(t)σₓ−γᵢ(t)σ_{y}+ϵᵢ(t)σ_{z}) represents the sum of the possible fields \vec{F}_{ι}, where \vec{F}=Σᵢ(\vec{F}_{ι}(t)), and \vec{σ}=(σₓ, σ_{y}, σ_{z}), is the vector of Pauli matrices corresponding to the system.

15. A quantum system comprising:
one or more drift fields;
one or more particles immersed in the one or more drift fields;
wherein the one or more particles immersed in the one or more drift fields are in an initial quantum state |ψᵢ [symbol] , defined as the ground (eigen) state of the drift Hamiltonian H₀(t) at time t=0;
at least one control field generator configured to generate one or more time dependent control fields \vec{F};
wherein the generator is configured to drive the particle to a final quantum state |ψ_{f} [symbol] , defined as the ground (eigen) state of the drift Hamiltonian H₀(t) at time t=τ by means of the one or more time dependent control fields \vec{F}, wherein the one or more time dependent control fields \vec{F} are characterized in that \vec{F}=Σᵢ(\vec{F}_{ι}(t)); with \vec{F} determined by:
providing a time dependent Hermitian drift Hamiltonian H₀(t), an initial state |ψᵢ [symbol] , a final state, |ψ_{f} [symbol] , and either a finite energy resource of the control protocol v_{z}(t), or a protocol time τ and a functional form of v_{z}(t) with respect to time t;
iteratively equating an equation expressed as ∫₀^{τ}v_{z}(t)dt=arc cos| [symbol] ψᵢ|ψ′_{f} [symbol] |, wherein, in each iteration, values of either a protocol time τ or values of a finite energy resource of the control protocol v_{z}(t), are modified until both sides of the equation are at least substantially equal; obtaining thereby either a protocol time τ or a finite energy resource of the control protocol v_{z}(t);
constructing a control protocol Hamiltonian in an interaction picture with respect to H₀(t), H′_{c}(t) according to
$${H}_{c}^{′} ( t ) = \frac{i {v}_{z} ( t )}{\sqrt{1 - {s}^{2}}} ( {e}^{- i β} \vert {ψ}_{f}^{′} 〉 〈 {ψ}_{i} \vert - {e}^{i β} \vert {ψ}_{i} 〉 〈 {ψ}_{f}^{′} \vert )$$
where s and β are defined through [symbol] ψᵢ|ψ′_{f}(τ) [symbol] = [symbol] ψᵢ| [symbol] ₀^{†}(τ)|ψ_{f} [symbol] =se^{iβ}, and parameters in the interaction picture represent, each:
s modulus;
β phase;

|ψ′_{f} [symbol] the final state |ψ_{f} [symbol] , in the interaction picture, with |ψ′_{f} [symbol] = [symbol] ₀^{†}(τ)|ψ_{f} [symbol] , where [symbol] ₀(τ)= [symbol] exp(−i∫₀^{τ}H₀(t₁)dt₁) and [symbol] defines a time ordering operator; and
† means conjugate transpose;
determining the control protocol Hamiltonian in the Schrödinger picture as H_{c}(t)= [symbol] ₀(t)H′_{c}(t) [symbol] ₀^{†}(t); and
establishing a one-to-one correspondence between the interaction of one or more fields \vec{F}_{ι} with an N level system and the control protocol Hamiltonian H_{c}(t).

16. The quantum system according to claim 15, wherein \vec{F} is determined by:
before establishing a one-to-one correspondence between the interaction of \vec{F}_{ι} with an N level system, time-evolving the initial state |ψᵢ [symbol] , during the protocol time τ, according to the following time-dependent Schrödinger equation:
$$i \frac{d}{dt} \vert ψ ( t ) 〉 = H ( t ) \vert ψ ( t ) 〉 ,$$
where H(t)=H₀(t)+H_{c}(t),
or equivalently |ψ(t) [symbol] = [symbol] ₀(t) [symbol] _{c}(t)|ψᵢ [symbol] , where i [symbol] _{c}(t)=H′_{c}(t) [symbol] _{c}(t);
where the energy resource of the control protocol v_{z}(t) is provided and assumed independent from time and equal to v_{z}, and wherein computing the protocol time τ is performed by iteratively computing an equation expressed as
$$τ = \frac{1}{{v}_{z}} arccos \vert ( {ψ}_{i} \vert {ψ}_{f}^{′} 〉 \vert ,$$
where, in each iteration, values of protocol time τ are modified until both sides of the equation are at least substantially equal.

17. The quantum system according to claim 15, wherein:
the one or more drift fields comprise at least a unidirectional magnetic field B_{z0}(t);
the one or more particles comprise one particle characterized by a spin ½, a mass m, a g-factor g and a charge q; the one particle is immersed in the unidirectional magnetic field B_{z0}(t); wherein the one particle is in an initial quantum state |ψᵢ [symbol] defined as the ground (eigen) state of the drift Hamiltonian H₀(t) at time t=0;
where the unidirectional magnetic field B_{z0}(t) and the one particle are defined by a time dependent Hermitian drift Hamiltonian
$${H}_{0} ( t ) = - \frac{ξ}{2} {B}_{z o} ( t ) {σ}_{z} ,$$
where ξ=gq/2m;
the at least one field generator comprises at least one magnetic field generator configured to generate a three-dimensional time dependent magnetic field \vec{B}(t) defined by the following components
$${B}_{x} ( t ) = - \frac{2 μ ( t )}{ξ} , {B}_{y} ( t ) = \frac{2 γ ( t )}{ξ} , {B}_{z} ( t ) = - \frac{2 ϵ ( t )}{ξ}$$
wherein the at least one magnetic field generator is configured to drive the particle to a final quantum state |ψ_{f} [symbol] , defined as the ground (eigen) state of the drift Hamiltonian H₀(t) at time t=τ by means of the one or more time dependent control fields \vec{F}, wherein the one or more time dependent control fields \vec{F} comprises a time dependent magnetic field \vec{B}(t), wherein the time dependent magnetic field \vec{B}(t) is characterized in that
$$H ( t ) = {H}_{0} ( t ) + {H}_{c} ( t ) = - \frac{ξ}{2} {B}_{zo} ( t ) {σ}_{z} - ξ \vec{B} ( t ) \cdot \vec{S} = - \frac{ξ}{2} {B}_{zo} ( t ) {σ}_{z} - \frac{ξ}{2} ( {B}_{x} ( t ) {σ}_{x} + {B}_{y} ( t ) {σ}_{y} + {B}_{z} ( t ) {σ}_{z} ) ,$$
with the control protocol Hamiltonian
$${H}_{c} ( t ) = {𝒰}_{0} ( t ) {H}_{c}^{′} ( t ) {𝒰}_{0}^{†} ( t ) = - \frac{ξ}{2} ( {B}_{x} ( t ) {σ}_{x} + {B}_{y} ( t ) {σ}_{y} + {B}_{z} ( t ) {σ}_{z} ) .$$

18. The quantum system according to claim 15, wherein:
the one or more drift fields comprise at least a unidirectional magnetic field B_{z0}(t);
the one or more particles comprise one particle characterized by a spin ½, a mass m, a g-factor g and a charge q; the one particle is immersed in the unidirectional magnetic field B_{z0}(t); wherein the one particle is in an initial quantum state |ψᵢ [symbol] defined as the ground (eigen) state of the drift Hamiltonian H₀(t) at time t=0;
where the unidirectional magnetic field B_{z0}(t) and the one particle are defined by a time dependent Hermitian drift Hamiltonian
$${H}_{0} ( t ) = - \frac{ξ}{2} {B}_{zo} ( t ) {σ}_{z} ,$$
where ξ=gq/2m;
the at least one field generator comprises at least one magnetic field generator configured to generate a three-dimensional time dependent magnetic field \vec{B}(t) defined by the following components
$${B}_{x} ( t ) = - \frac{2 μ ( t )}{ξ} , {B}_{y} ( t ) = \frac{2 γ ( t )}{ξ} , {B}_{z} ( t ) = - \frac{2 ϵ ( t )}{ξ}$$
wherein the at least one magnetic field generator is configured to drive the particle to a final quantum state |ψ_{f} [symbol] , defined as the ground (eigen) state of the drift Hamiltonian H₀(t) at time t=τ by means of the one or more time dependent control fields \vec{F}, wherein the one or more time dependent control fields \vec{F} comprises a time dependent magnetic field \vec{B}(t) , wherein the time dependent magnetic field \vec{B}(t) is characterized in that
$$H ( t ) = {H}_{0} ( t ) + {H}_{c} ( t ) = - \frac{ξ}{2} {B}_{zo} ( t ) {σ}_{z} - ξ \vec{B} ( t ) \cdot \vec{S} = - \frac{ξ}{2} {B}_{zo} ( t ) {σ}_{z} - \frac{ξ}{2} ( {B}_{x} ( t ) {σ}_{x} + {B}_{y} ( t ) {σ}_{y} + {B}_{z} ( t ) {σ}_{z} ) ,$$
with the control protocol Hamiltonian
$${H}_{c} ( t ) = {𝒰}_{0} ( t ) {H}_{c}^{′} ( t ) {𝒰}_{0}^{†} ( t ) = - \frac{ξ}{2} ( {B}_{x} ( t ) {σ}_{x} + {B}_{y} ( t ) {σ}_{y} + {B}_{z} ( t ) {σ}_{z} ) ,$$
and wherein the initial state |ψᵢ [symbol] is time-evolved during the protocol time τ, according to the following time-dependent Schrödinger equation:
$$i \frac{d}{dt} \vert ψ ( t ) 〉 = H ( t ) \vert ψ 〉 , where H ( t ) = {H}_{0} ( t ) + {H}_{c} ( t ) , \\ or equivalently \vert ψ ( t ) 〉 = {𝒰}_{0} ( t ) {𝒰}_{c} ( t ) \vert {ψ}_{i} 〉 , where i {\dot{𝒰}}_{c} ( t ) = {H}_{c}^{′} ( t ) {𝒰}_{c} ( t ) .$$

19. The quantum system according to claim 15, wherein:
the one or more drift fields comprise at least a unidirectional magnetic field B_{z0}(t);
the one or more particles comprise one particle characterized by a spin ½, a mass m, a g-factor g and a charge q; the one particle is immersed in the unidirectional magnetic field B_{z0}(t); wherein the one particle is in an initial quantum state |ψᵢ [symbol] defined as the ground (eigen) state of the drift Hamiltonian H₀(t) at time t=0;
where the unidirectional magnetic field B_{z0}(t) and the one particle are defined by a time dependent Hermitian drift Hamiltonian
$${H}_{0} ( t ) = - \frac{ξ}{2} {B}_{zo} ( t ) {σ}_{z} ,$$
where ξ=gq/2m;
the at least one field generator comprises at least one magnetic field generator configured to generate a three-dimensional time dependent magnetic field \vec{B}(t) defined by the following components
$${B}_{x} ( t ) = - \frac{2 μ ( t )}{ξ} , {B}_{y} ( t ) = \frac{2 γ ( t )}{ξ} , {B}_{z} ( t ) = - \frac{2 ϵ ( t )}{ξ}$$
wherein the at least one magnetic field generator is configured to drive the particle to a final quantum state |ψ_{f} [symbol] , defined as the ground (eigen) state of the drift Hamiltonian H₀(t) at time t=τ by means of the one or more time dependent control fields, wherein the one or more time dependent control fields \vec{F} comprises a time dependent magnetic field \vec{B}(t), wherein the time dependent magnetic field \vec{B}(t) is characterized in that
$$H ( t ) = {H}_{0} ( t ) + {H}_{c} ( t ) = - \frac{ξ}{2} {B}_{zo} ( t ) {σ}_{z} - ξ \vec{B} ( t ) \cdot \vec{S} = - \frac{ξ}{2} {B}_{zo} ( t ) {σ}_{z} - \frac{ξ}{2} ( {B}_{x} ( t ) {σ}_{x} + {B}_{y} ( t ) {σ}_{y} + {B}_{z} ( t ) {σ}_{z} ) ,$$
with the control protocol Hamiltonian
$${H}_{c} ( t ) = {𝒰}_{0} ( t ) {H}_{c}^{′} ( t ) {𝒰}_{0}^{†} ( t ) = - \frac{ξ}{2} ( {B}_{x} ( t ) {σ}_{x} + {B}_{y} ( t ) {σ}_{y} + {B}_{z} ( t ) {σ}_{z} )$$
to, before establishing a one-to-one correspondence between the interaction of \vec{F}_{ι} with an N level system, determining the control protocol Hamiltonian in the Schrödinger picture by solving dH_{c}/dt=−i[H₀, H_{c}] and assuming v_{z}(t)=v_{z}.

20. The quantum system according to claim 15, wherein:
the one or more drift fields comprise at least an optical lattice, the optical lattice comprising one or more laser sources;
the one or more particles comprise one or more atoms trapped in the optical lattice and defined by a time dependent Hermitian two-level drift Hamiltonian H₀(t)=Γ_{zo}(t)σ_{z} and the one more atoms in an initial quantum state |ψᵢ [symbol] defined as the ground (eigen) state of the drift Hamiltonian H₀(t) at time t=0;
the at least one field generator comprises at least one or more lasers sources configured to drive the one or more atoms trapped in the optical lattice to a final quantum state |ψ_{f} [symbol] defined as the ground (eigen) state of the drift Hamiltonian H₀(t) at time t=τ, wherein the at least one or more lasers sources are characterized in that
H(t)=H₀(t)+H_{c}(t)=Γ_{zo}(t)σ_{z}+(Γₓ(t)σₓ+Γ_{y}(t)σ_{y}+Γ_{z}(t)σ_{z}),
with a control protocol Hamiltonian H_{c}(t)=Γₓ(t)σₓ+Γ_{y}(t)σ_{y}+Γ_{z}(t)σ_{z}= [symbol] ₀(t)H′_{c}(t) [symbol] ₀^{†}(t).
